(19) United States
(12) Patent Application Publication
(10) Pub. No.: US 2008/0294524 A1
(43) Pub. Date: Nov. 27, 2008

(54) Site-Targeted Advertising

(75) Inventors: Gregory Joseph Badros, Palo Alto, CA (US); Brian Axe, Portola Valley, CA (US); Sumit Agarwal, Mountain View, CA (US); Leora Ruth Wiseman, Sunnyvale, CA (US); Deepak Jindal, San Francisco, CA (US)

Correspondence Address: FISH & RICHARDSON P.C., PO BOX 1022, MINNEAPOLIS, MN, 55440-1022, US

(73) Assignee: GOOGLE INC., Mountain View, CA (US)

(21) Appl. No.: 12/047,239

(22) Filed: Mar. 12, 2008

Related U.S. Application Data
(60) Provisional application No. 60/894,441, filed on Mar. 12, 2007.

(51) Int. Cl. G06Q 30/00

(52) U.S. Cl. 705/14

(57) ABSTRACT

A method is provided. The method includes receiving at a central system advertisement identifiers associated with one or more advertisements, receiving one or more identifiers of web locations to be targeted by the advertisements, receiving one or more non-keyword bids for a display of each of the advertisements, and generating a score associated with each of the one or more advertisements using the non-keyword bid in an advertising auction.

### RELATED APPLICATIONS

This application claims the benefit under 35 U.S.C. § 119 of U.S. Provisional Application No. 60/894,441, titled “Site-Targeted Advertising,” filed Mar. 12, 2007, which is incorporated by reference herein in its entirety.

### BACKGROUND

This document relates to targeted advertising.

As the Internet has grown, online advertising has become a popular method by which advertisers can reach consumers. Online advertising provides opportunities for advertisers to target their ads to a receptive audience.

Typically, an online advertiser can target advertisements to keywords. For example, the advertiser can target advertisements to keywords used in search queries. If a targeted keyword is used by a user in a search query, advertisements targeted to that keyword may appear in the search results for the search query. As another example, an advertisement can be targeted to keywords that appear on a web page on which the advertisement is to be displayed, so that the advertisement will tend to match the content of the page. Advertisements targeted to these keywords may appear in web pages containing these keywords when users visit the web pages.

Advertisers can typically bid for advertisements placements as a cost per 1000 impressions (CPM) or a cost per click (CPC). CPM is often used by advertisers who wish to increase visibility and build brand awareness by having their advertisements appear often. CPC is often used by advertisers who is concerned with conversions from their advertisements.

### SUMMARY

In one implementation, a method is disclosed that comprises receiving at a central system advertisement identifiers associated with one or more advertisements, receiving one or more identifiers of web locations to be targeted by the advertisements, receiving one or more non-keyword bids for a display of each of the advertisements, and generating a score associated with each of the one or more advertisements using the non-keyword bid in an advertising auction. The method may further comprise selecting the one or more advertisements to display at the web locations if the generated score exceeds a determined level. In addition, the score associated with an advertisement can be generated by converting a keywordless score to a keyword-based score for comparison with keyword-based advertisements. Also, a score for an advertisement associated with a non-keyword bid can be generated for one or more displays of content associated with the web locations.

In some aspects, the one or more identifiers of web locations comprise a web domain, and can likewise comprise a URI. The one or more identifiers, the one or more identifiers of web locations, and the non-keyword bid can be received from a single device remote from the central system. In addition, the method may also include comparing the generated score to one or more scores for keyword-based bids for other advertisements.

In another implementation, a system for delivering targeted advertisements is disclosed. The system comprises computer storage storing a plurality of advertisements including keyword based advertisements and keywordless advertisements, an auction module to identify advertisements relevant to a view displayed to a user and to select candidate advertisements for display to the user, and an advertisement positioner programmed to generate and compare scores for the keyword based advertisements and the keywordless advertisements and to provide a set of ranked advertisements for display to the user. The advertisement positioner can be programmed to convert scores for keyword based advertisements into a format for keywordless advertisements before comparing the scores. In addition, the advertisement positioner can be programmed to convert scores for keywordless advertisements into a format for keyword based advertisements before comparing the scores.

In some aspects, the advertisements are site-targeted advertisements. In addition, the ad positioner can be part of the auction module in certain implementations.

### BRIEF DESCRIPTION OF DRAWINGS

FIG. 1 is a conceptual diagram of an example system for accepting and displaying on-line targeted advertisements.

FIGS. 2A-2E illustrate an example user interface for viewing and managing an advertising campaign.

FIGS. 3A-3M are screen shots of a user interface for establishing an ad group.

FIG. 4 is a block diagram of example steps for adding web sites to a targeted ad campaign.

FIG. 5 illustrates examples of advertisement placements.

FIGS. 6A-6B illustrate example auctions for advertisement placements.

FIGS. 7A-7B illustrate an example user interface for selecting a bidding model for a newly created advertising campaign.

FIGS. 8A-8D illustrate an example user interface for changing the bidding model for an existing advertisement campaign.

FIG. 9 is a diagram showing parties or entities that can interact with an advertising system.

FIG. 10 is a diagram illustrating an example advertising environment.

FIG. 11 is a bubble diagram illustrating exemplary operations in an advertising environment.

FIG. 12 illustrates different notions of advertiser value and how they can be determined.

FIG. 13 is a flow diagram illustrating an example process for providing an advertiser user interface.

FIG. 14 illustrates an example template through which an advertiser can specify desired ad spot characteristics and enter different types of offers.

FIG. 15 is a flow diagram illustrating an example process for serving ads.

FIG. 16 is a flow diagram illustrating an example process for billing advertisers.

FIG. 17 is a block diagram illustrating an example generic computer an example generic mobile computer device.

### DETAILED DESCRIPTION

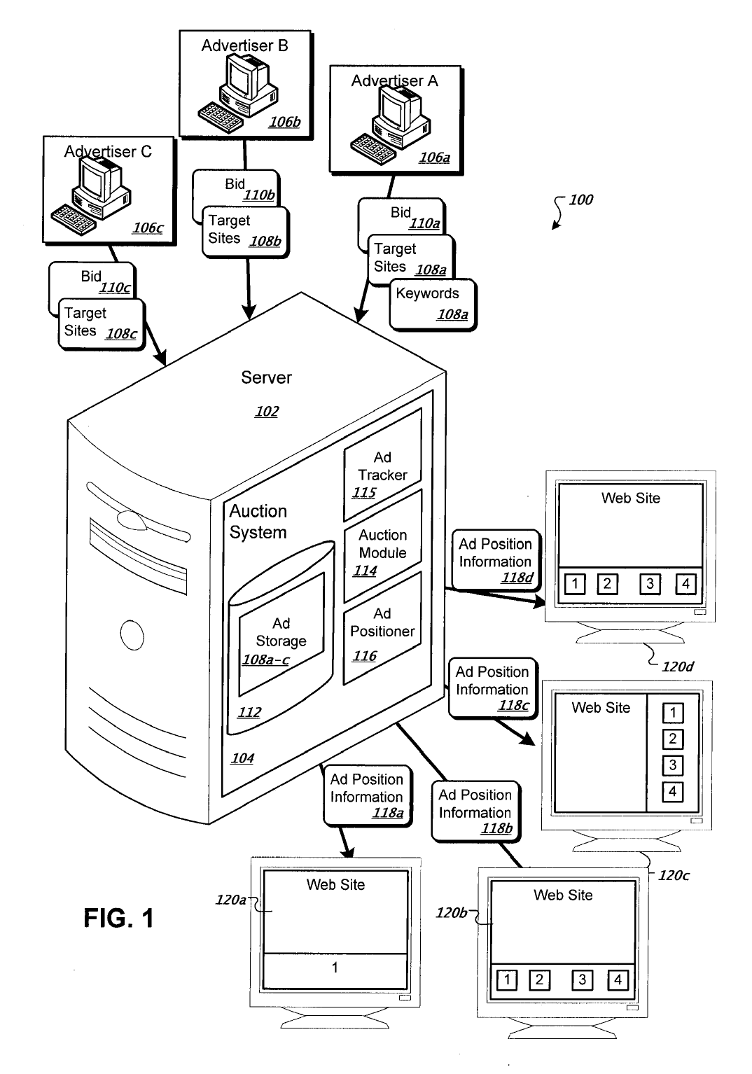

FIG. 1 is a conceptual diagram of an example system 100 for accepting and displaying on-line targeted advertisements. In general, the system 100 permits various advertisers to submit advertisements, and to define or have defined for them identifiers that point to the advertisements. The advertisements, or ads, may be site-targeted, in that the advertisers may select particular domains (e.g., www.cnn.com or www.nytimes.com) or particular pages within a domain, on which they would like the advertisements to be displayed. In this way, advertisers can better target particular demographics groups to which they would like to direct their advertising. Various mechanisms described below may also help advertisers select such domains, pages, or groups of domains and/or pages. While reference is made to advertisements, system 100 can provide other forms of content including other forms of sponsored content.

Advertisers may be provided with a choice of the type of advertisements to be run. For example, advertisers may select to show graphical ads, animated ads, or just textual ads. The various types of ads may be of various sizes, and the size of an ad may be taken into account in determining whether or where to display it, i.e., larger ads may require higher bids in order to be displayed in a system that auctions off ad positions.

Advertisers (which may include agents of the advertisers) may also be provided with a choice of the manner in which they would like to be billed for the display, or reactions to the display, of their advertisements. For example, advertisers may choose to pay by the number of impressions (CPM bidding), by the number of clicks on an ad (CPC), or by the number of conversions generated in response to an ad (e.g., with Javascript code embedded at a purchasing site associated with the advertiser). CPC can be based on actual data or it can be an estimated CPC based on predictive data as discussed more fully below.

While many advertisers will choose traditional keyword-associated selection for ads, the system 100 may also provide for advertisers to choose to have the ads selected without regard to keywords. For example, a bid price for the advertisement may be used alone to provide the ad with a score, particularly when the ad is new and users have not had an opportunity to react to it. The assumption is that an advertiser has already determined that the ad is relevant to users by first targeting a particular site. As the ad is displayed one or more times on the site, the system 100 may begin to determine whether the ad is actually germane to the site, such as by monitoring if, when, and how often users reacts to the ad, such as by clicking on it to be taken to an advertiser-related web site. The level of reaction, as determined across multiple displays of the ad, may then be used along with the bid amount to score the ad relative to other ads for determining whether and where to display the ad. Such keyword-less selection may be paired, for example, with CPC billing for ads.

The system 100 includes a server 102 containing an auction system 104. The auction system 104 is in communication with one or more advertisers 106a-c, such as by telephone, mail, or a computer network. The auction system 104 receives target sites 108a-c of desired web sites (domains, web pages, or groups of domains and/or web pages) from each of the advertisers 106a-c, respectively. In addition, each of advertisers 106a-c may submit identifiers for advertisements (which may be uploaded to server 102 or may be preexisting on server 102) along with bids 110a-c respectively for the display of the advertisements.

Certain bids may be accompanied by keywords 111a that the advertiser would like to use to trigger selection of the associated ad or ads. For example, a bicycle company may target an outdoors magazine, but may want their ads displayed only to users who search on keywords like “bike,” “cycle,” “mountain,” and “trails,” or displayed only on pages within the site that contain such keywords. Other advertisers may select to submit keyword-less ads, in that the ads may be selected for display only upon the amount of a bid or a combination of the bid amount and, for example, an observed popularity of the ad on a particular targeted site. In addition, the system 100 may analyze the words in an ad or words at a web site to which a link in an ad points, to generate keywords that can also be used in choosing to display certain ads in response to certain search or on certain web pages.

The auction system 104 stores the target sites 108a-c, the bids 110a-c, and the keywords 111a in ad repository 112. Ads are stored separately in ad storage 109 within ad repository 112. An auction module 114, within the auction system 104, selects bids that are responsive to actions by a user (e.g., a user's submission of search terms or a user's viewing of a certain web page) and ranks the advertisers' eligible bids, for example, from lowest to highest. An eligible bid may be, for example, a bid that meets a reserve bid price, or a minimum bid amount.

An ad positioner 116 determines what slot, if any, will be assigned to each of the advertisers 106a-c. In some implementations, the ad positioner 116 makes a slot assignment to each of the advertisers 106a-c in order from an advertiser (e.g., the advertiser 106a) with a highest eligible bid to an advertiser (e.g., the advertiser 106c) with a lowest eligible bid. The positioning may place highest scoring ads at the top and lowest at the bottom, or may place the ads according to a determined (by the system 100) or perceived (by an advertiser) best order, such as according to where studies show that users first look when receiving ads. For example, the top scoring ad may be displayed at the top of the ads, and the second best scoring ad may be placed at the bottom, if such a position is determined or perceived to be better than second-from-the-top.

The ad positioner 116 transmits the assignments in ad position information 118a-d to be applied to one or more media 120a-d, such as various targeted web pages. The selection of ads for display/presentation, and the ordering of the ads may be hybrid in various senses. As one such example explains in more detail below, ads having keywords may be scored against ads not having keywords, or ads for which billing is based on CPM may be scored against ads for which billing is based on CPC. A mixture of all such selections may likewise be permitted in the scoring of ads in an auction also.

In determining which ads to select for display, auction module 114 may rely on information gathered by ad tracker 115. Ad tracker 115 may monitor the display of ads and make determinations regarding user reactions to the ads. For example, ad tracker 115 may determine whether a particular ad was clicked on, and in some cases, whether a user stayed at a site associated with the ad for a particular period of time (fast click-and-return times may indicate that the user did not like the result or the ad was misleading and not fairly reflective of the advertised material). In addition, the ad tracker 115 may determine whether a conversion (which may be defined in various manners for the system 100, and may include, for example, a purchase by a user from an advertiser of an advertised item in a way that can be associated with the display of the ad) has occurred.

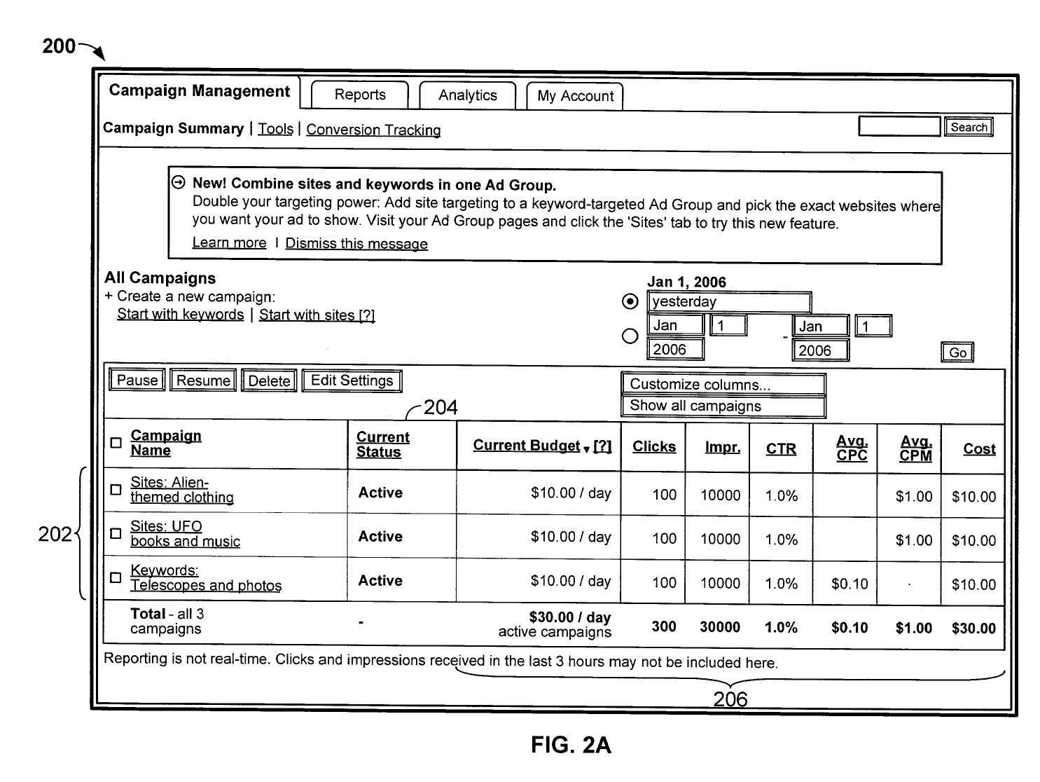

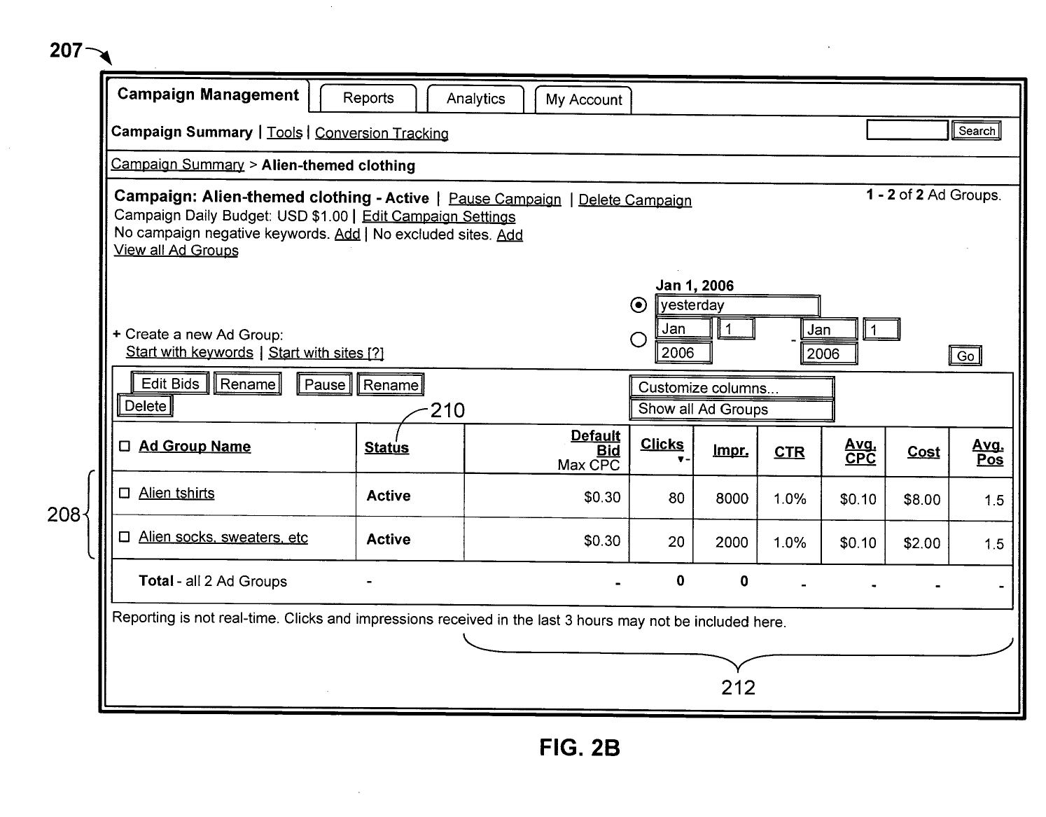

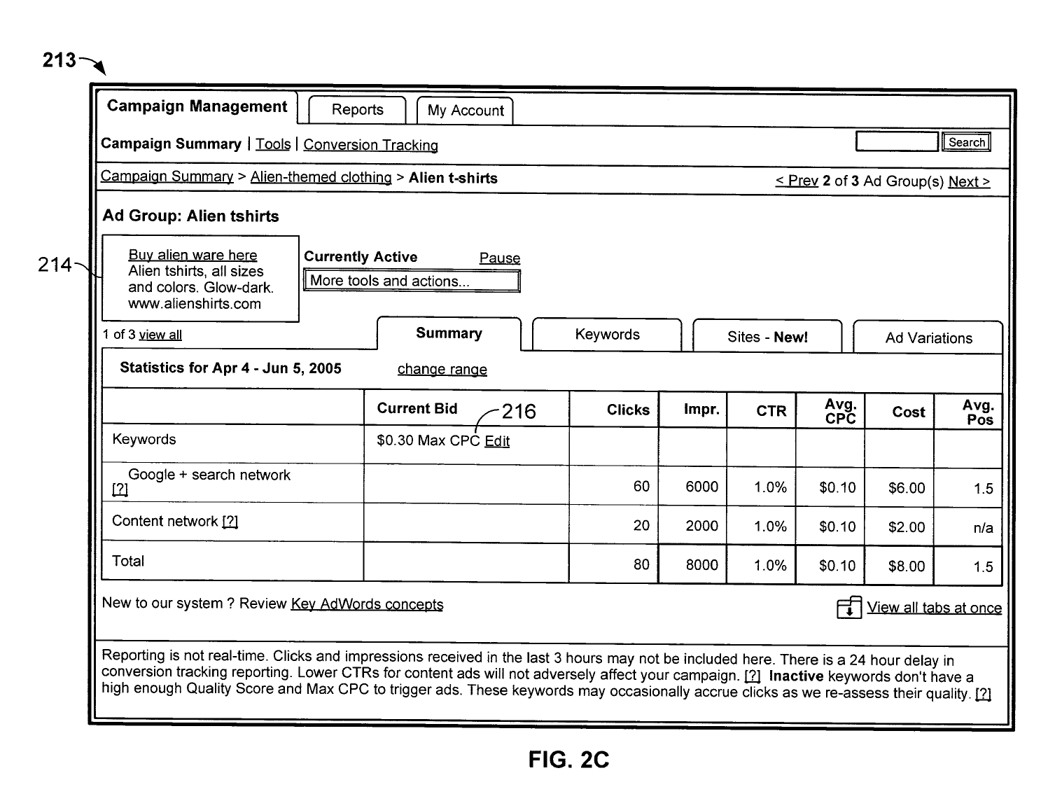

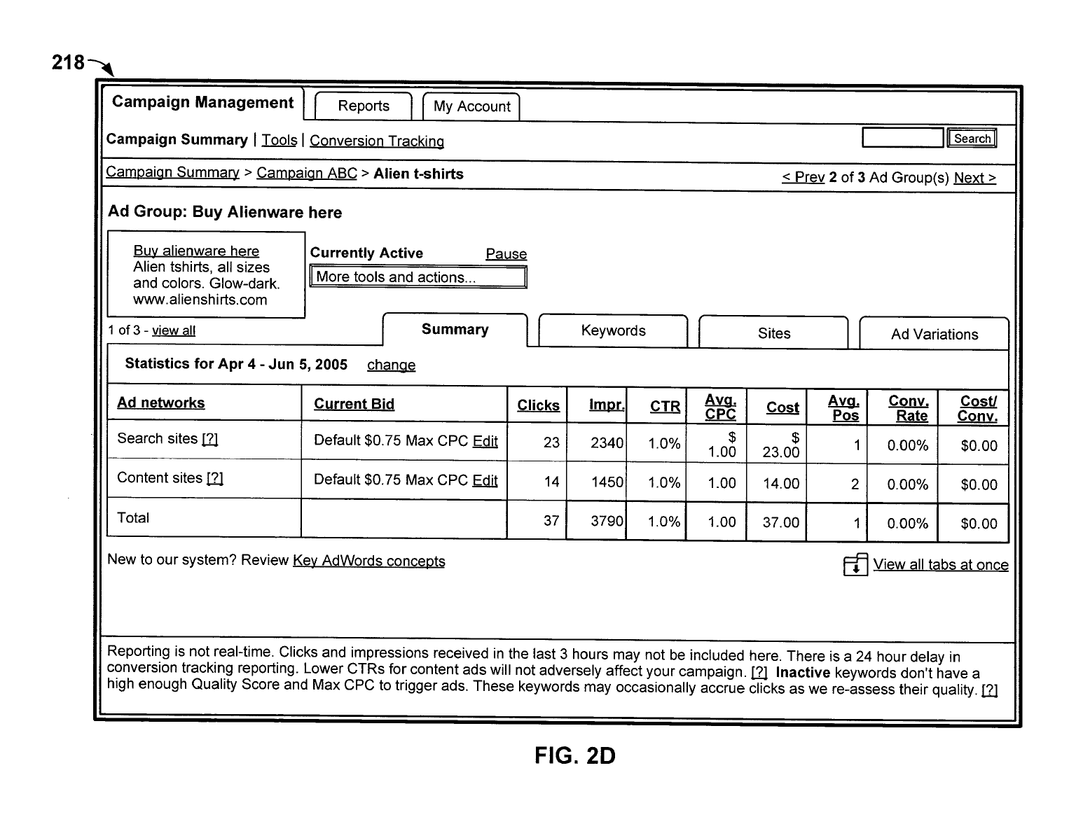

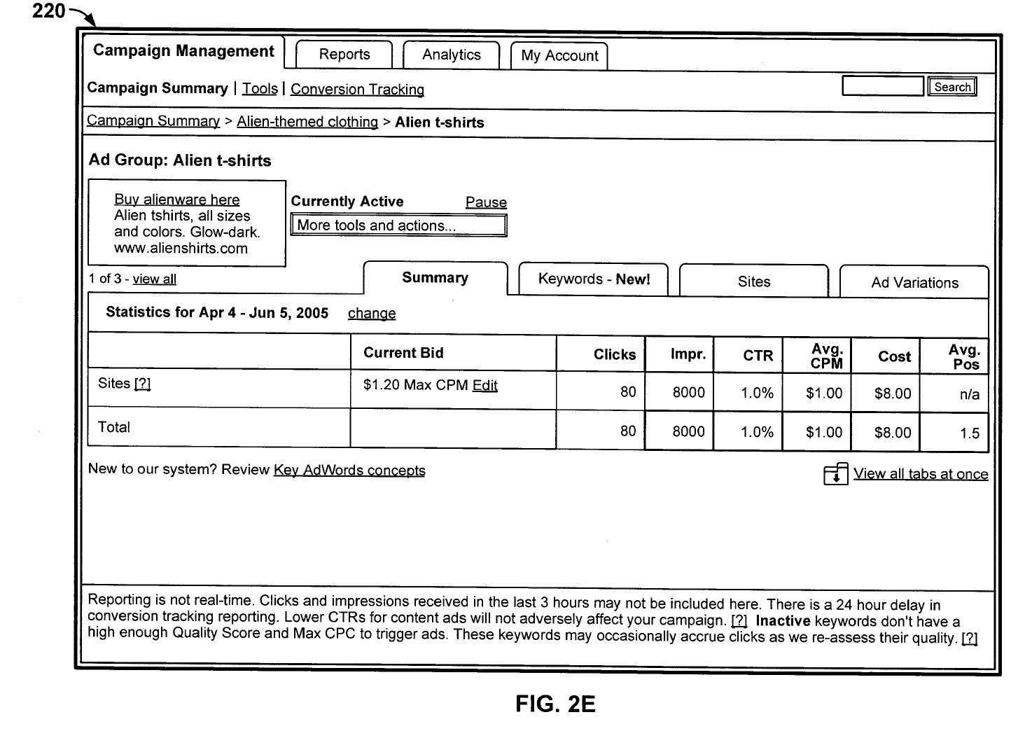

FIGS. 2A-2E illustrate an example user interface for viewing and managing an advertising campaign. FIG. 2A illustrates an example campaign management page 200 for an advertiser. The campaign management page 200 lists one or more advertising campaigns 202 created by the advertiser. The campaign management page also displays information for each of the listed campaigns, including, for example, their status 204 (e.g., active, paused, etc.) and one or more relevant statistics 206 for each of the campaigns (e.g., daily budget, click-throughs (or “clicks”), impressions, click-through rate (CTR), etc.). In FIG. 2A, the campaign management page indicates that the advertiser has an “alien-themed clothing” campaign, a “UFO books and music” campaign, and a “telescopes and photos” campaign.

FIG. 2B illustrates an example page 207 for displaying the details of a particular advertising campaign. Campaign details page 207 shows the details for the “alien-themed clothing” campaign. Within an advertising campaign, the advertiser can have one or more groups 208 of advertisements, or “ad groups.” In the “alien-themed clothing” campaign are an “alien tshirts” ad group and an “alien socks, sweaters, etc.” ad group. Page 207 also displays the status 210 of each ad group (e.g., active, paused, etc.) and one or more relevant statistics 212 for each ad group (e.g., default bid, clicks-throughs, impressions, click-through rate, average position of the ad when it is displayed, etc.). The ad groups shown have default bids that follow a CPC bidding or pricing model.

FIG. 2C illustrates an example page 213 for displaying the details of a particular ad group. Page 213 shows the statistics for the “alien tshirts” ad group for a specified time period. This particular ad group is selected based on keywords supplied by the advertiser. Page 213 shows one or more advertisement creatives 214 within the ad group (in this case, a text advertisement), targeting methods, and relevant statistics for each targeting method. The “alien tshirts” campaign is shown to use keyword targeting, targeting entities that belong to one or more networks of entities who have agreed to display advertisements. In some implementations, the networks of entities include a search engine network (which includes a search engine and its search partners) and a network of content providers who agreed to display advertising on their websites. For example, the “alien tshirts” campaign is shown as targeting a “Google+search network” (search engine network) and a “content network” (content providers network). Page 213 shows a current bid 216 for the keyword targeted placements in this ad group. The page 213 also shows relevant statistics for the keyword targeted placements, breaking the statistics down by the targeted network (search engine network, content providers network).

FIG. 2D shows an example page 218 for displaying the details of an ad group that is site-targeted. Page 218 shows the statistics of an “Buy Alienware here” ad group within a specified time period. The “Buy Alienware here” ad group is site-targeted; the ad group is targeted to specific websites selected by the advertiser, and in this instance the ad group is not associated with advertiser-selected keywords. The ad group can target search sites and content sites. The statistics shown are broken down by search sites and content sites.

When an ad group targets search sites, the advertiser can select particular sites from a group of sites belonging to a search engine network. Whenever a user performs a search query within one of the selected search engine network sites, an advertisement from the ad group may be presented along with the search results for the search without regard to what words or phrases were used in the search query. When an ad group targets content sites, the advertiser can select particular sites from a group of sites that belong to a content provider network. When a user visits one of the selected content provider network sites, an advertisement from the ad group may be presented. In either case, there is no keyword targeting.

The advertiser can have a common bid for both search site and content site placements, or separate bids for each. Page 218 shows the ad group as having separate bids (which happens to be the same value) for the search site placements and content site placements. The bids shown follow the CPC model. Page 218 also shows other data such as a conversion rate and the cost for each conversion.

FIG. 2E illustrates an ad group details page 220 similar to page 213 shown in FIG. 2C, but without the identification of keywords. In page 220, the “Alien t-shirts” ad group includes site-targeted placements. The bid for the site-targeted placements here follows a cost per 1000 impressions (CPM) model.

In the example ad groups shown above, the available bidding models include CPC bidding for keyword-targeted placements, CPC bidding for site-targeted placements, and CPM bidding for site-targeted placements. In some implementations, an ad group can target both keywords and sites, or sites but not keywords. The advertiser can enter a bid for keyword-targeted placements and a bid for site-targeted placements. In some implementations, the advertiser can also enter separate bids for each of the targeted networks. For example, an advertiser can enter a bid for keyword-targeted placements in a search engine network, a bid for keyword-targeted placements in a content provider network, and a bid for site-targeted placements. Separate bids for site-targeted placements in search engine network sites and for site-targeted placements in content provider network sites can also be entered by the advertiser, if they so choose. The separate bids within an ad group can be, for example, either CPM or CPC. For example, the advertiser can make a CPC bid for keyword-targeted placements and a CPC bid for site-targeted placements.

In some implementations, the advertiser can also mix CPM and CPC bids within an ad group. For example, the advertiser can make a CPC bid for keyword-targeted placements and a CPM bid for site-targeted placements, or vice versa. In some implementations, the advertiser can also mix bids within a targeting method. For example, the advertiser can include a combination of a CPC bid and a CPM bid for site-targeted placements.

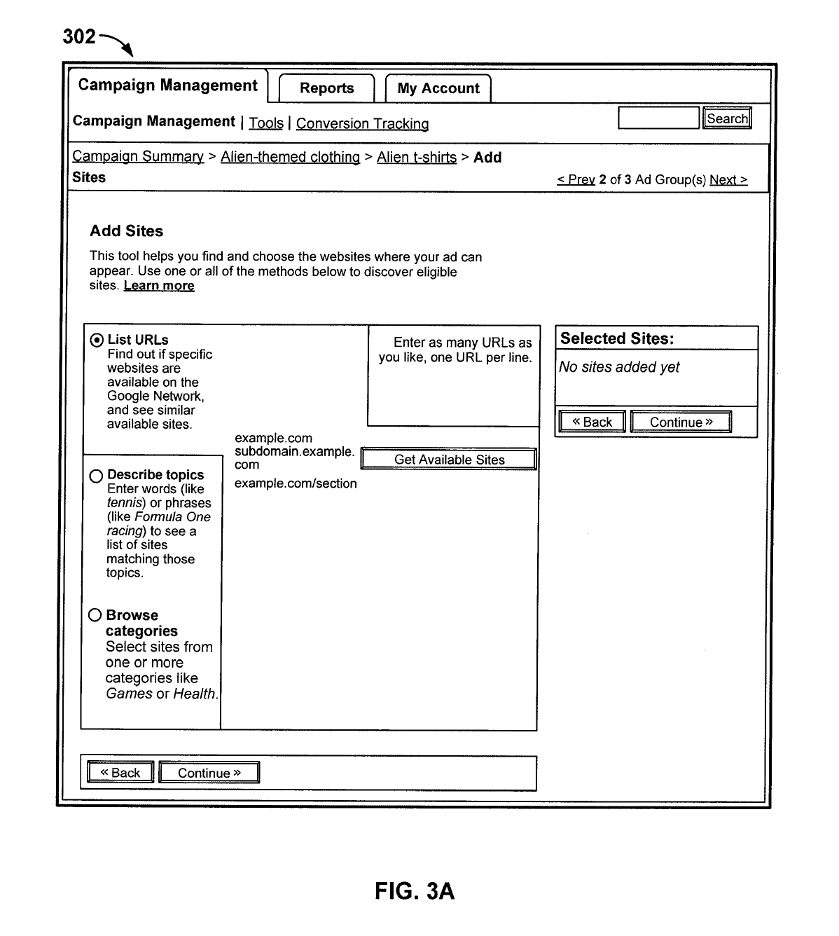

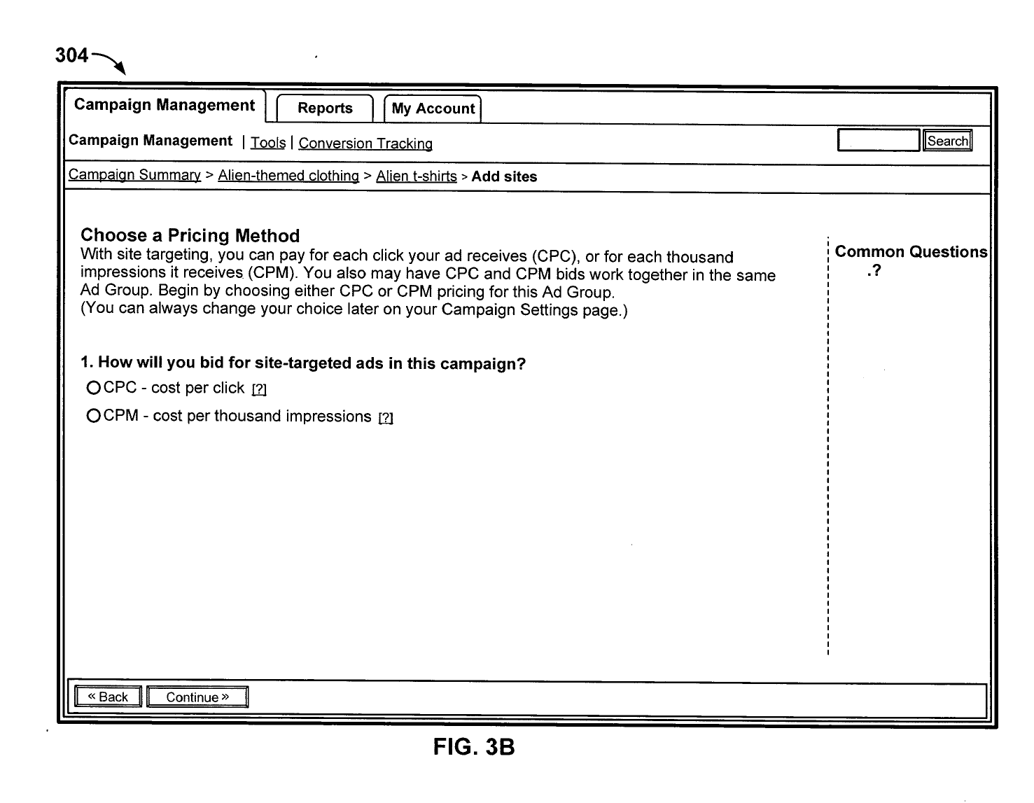

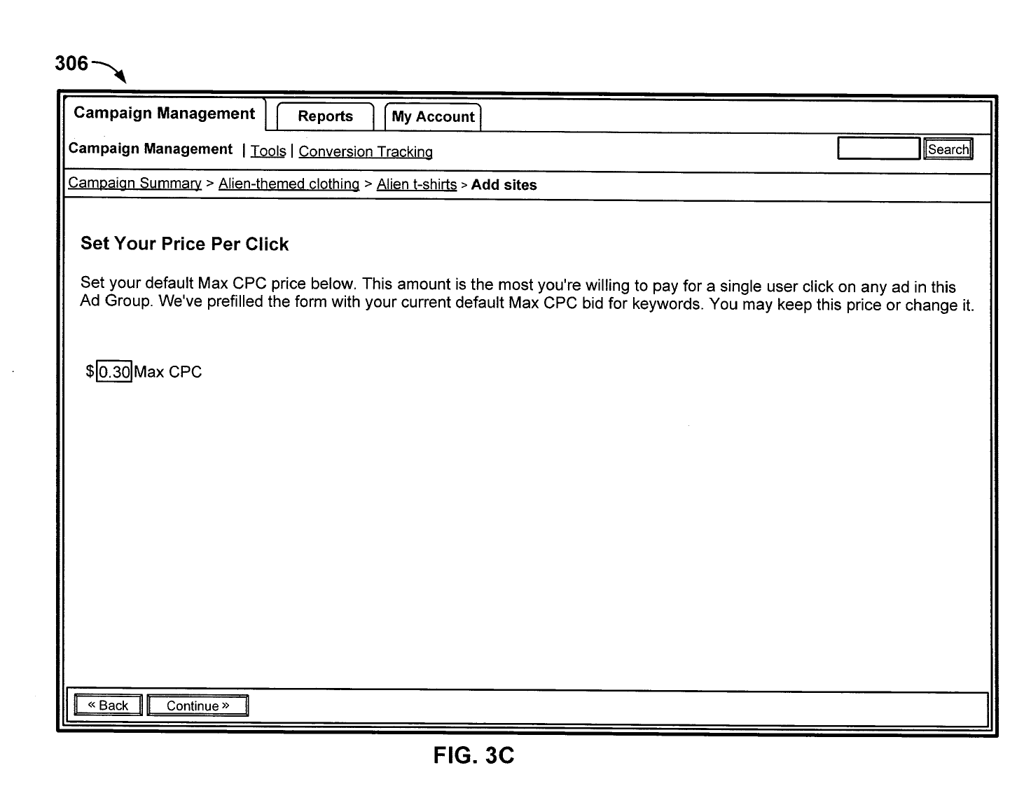

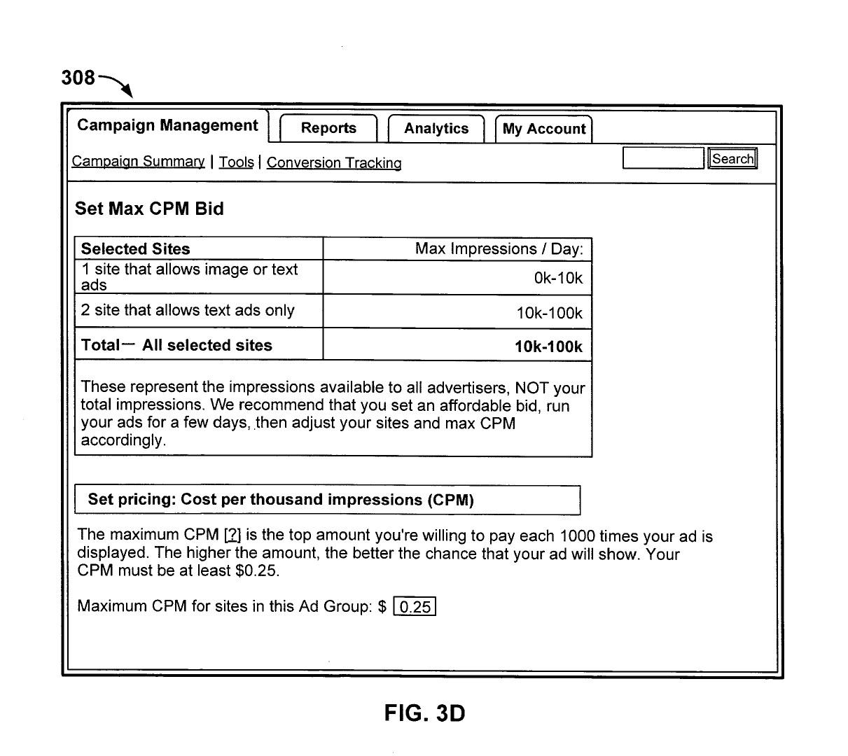

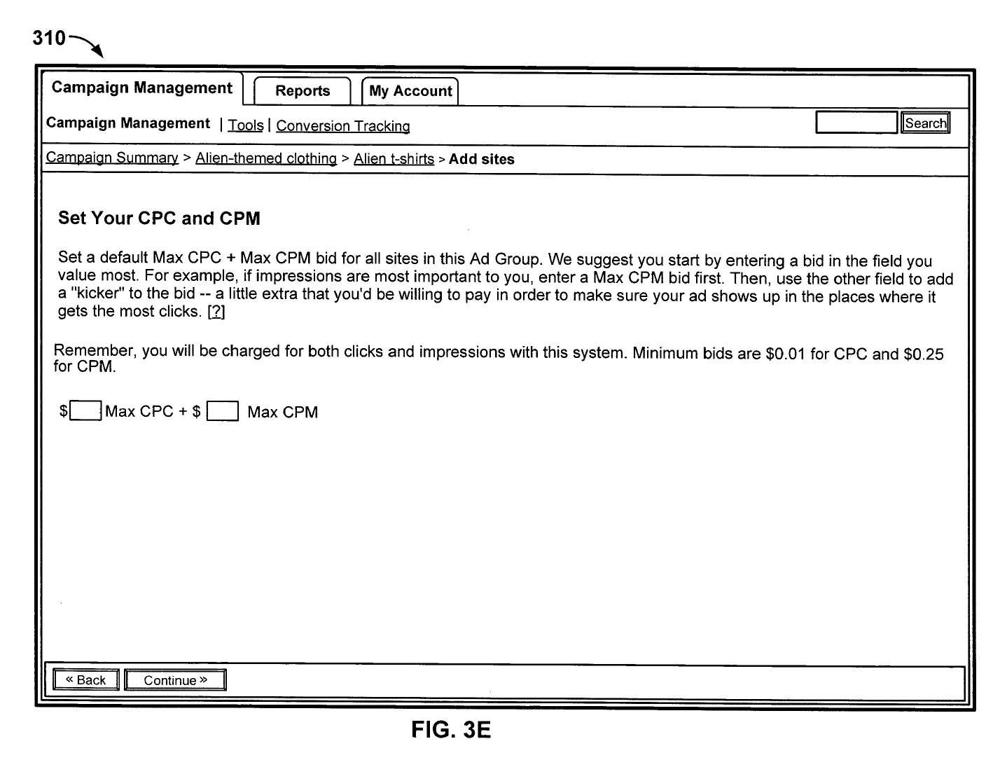

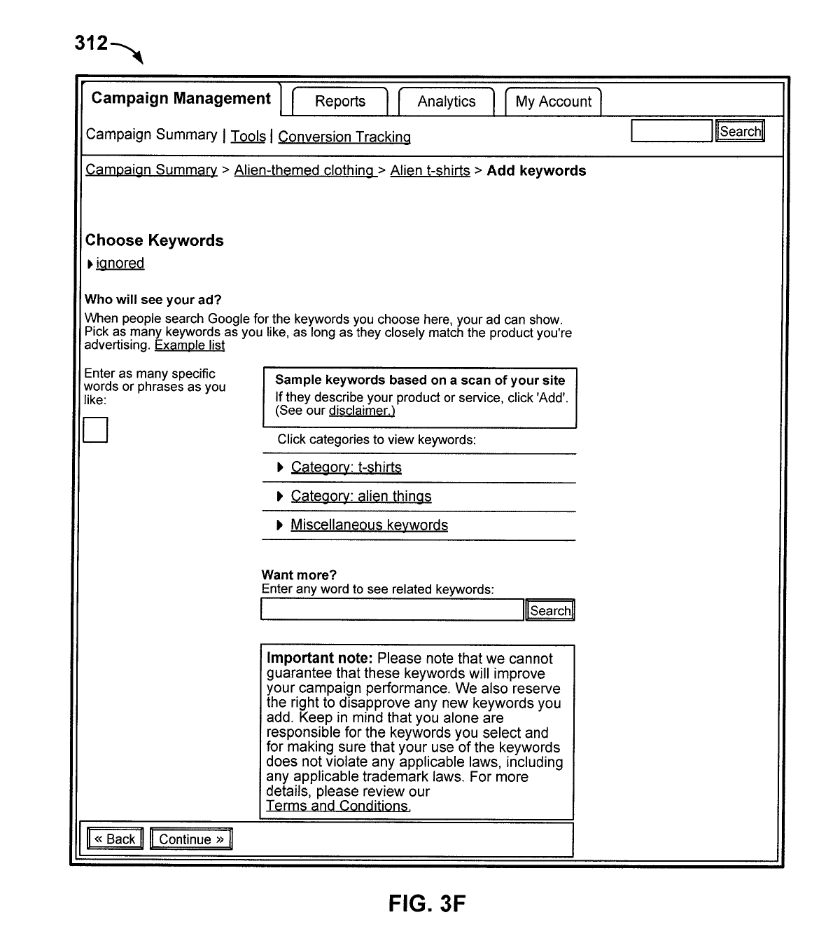

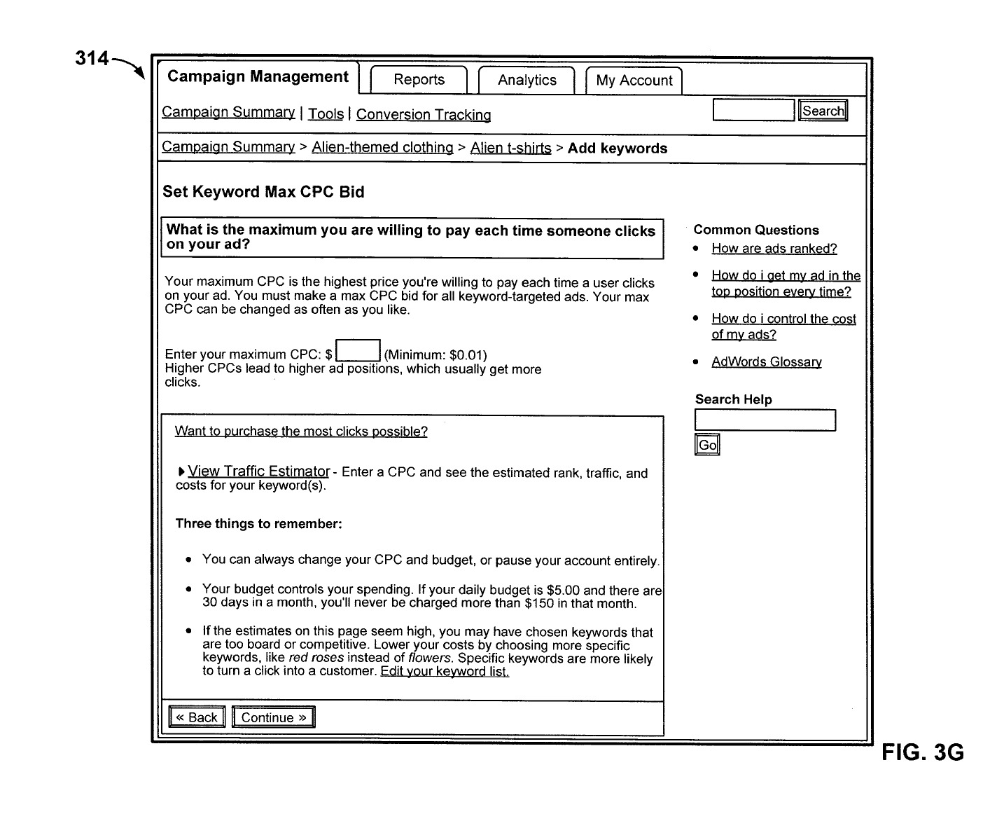

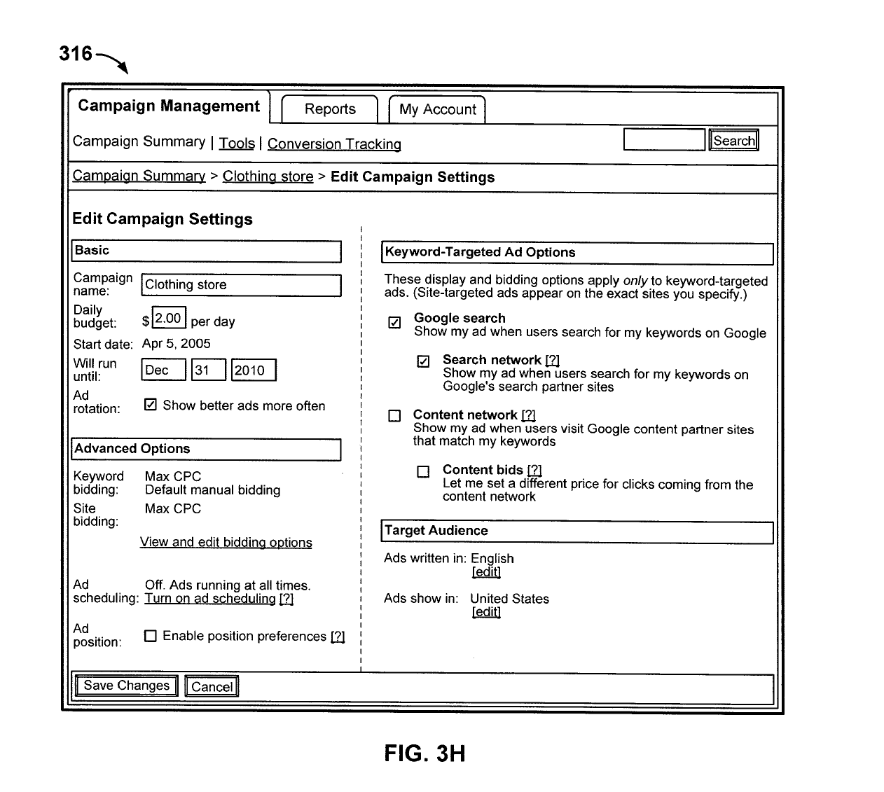

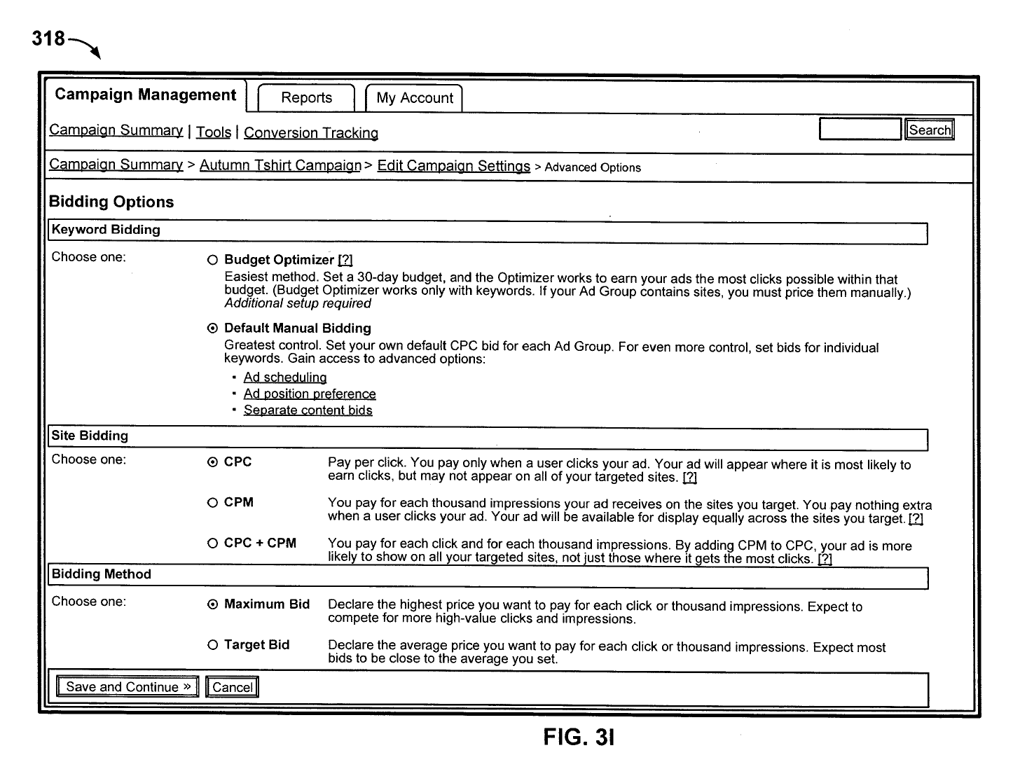

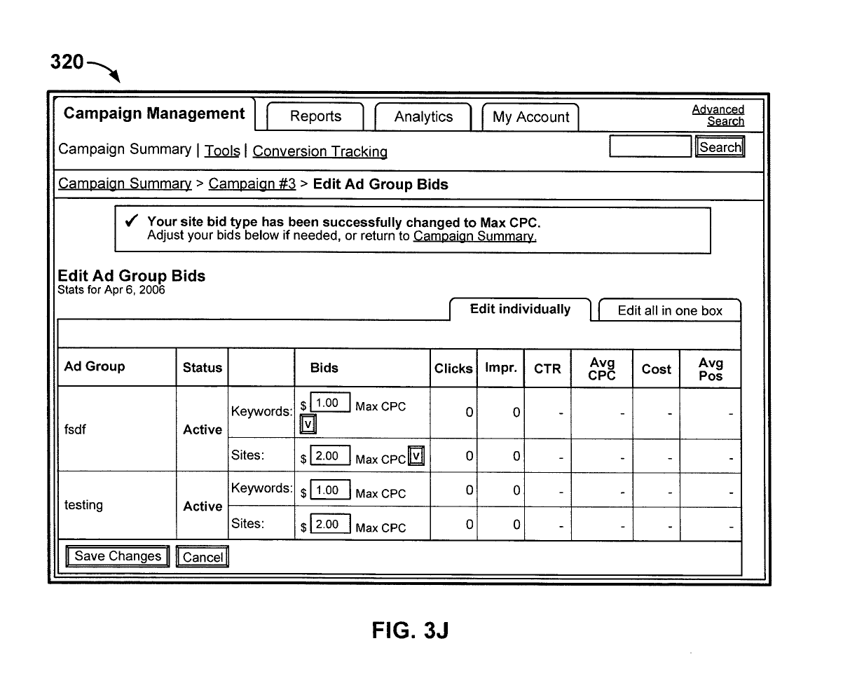

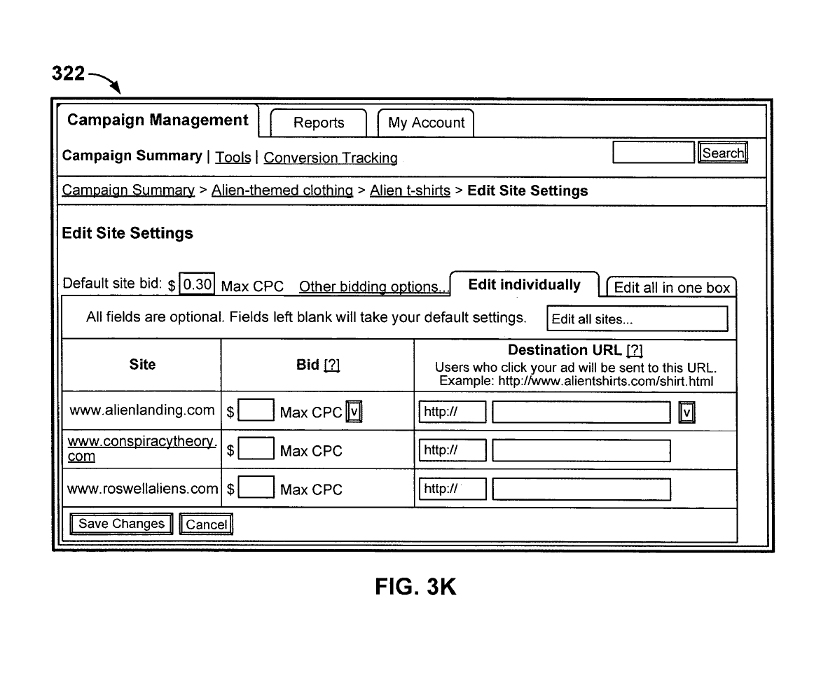

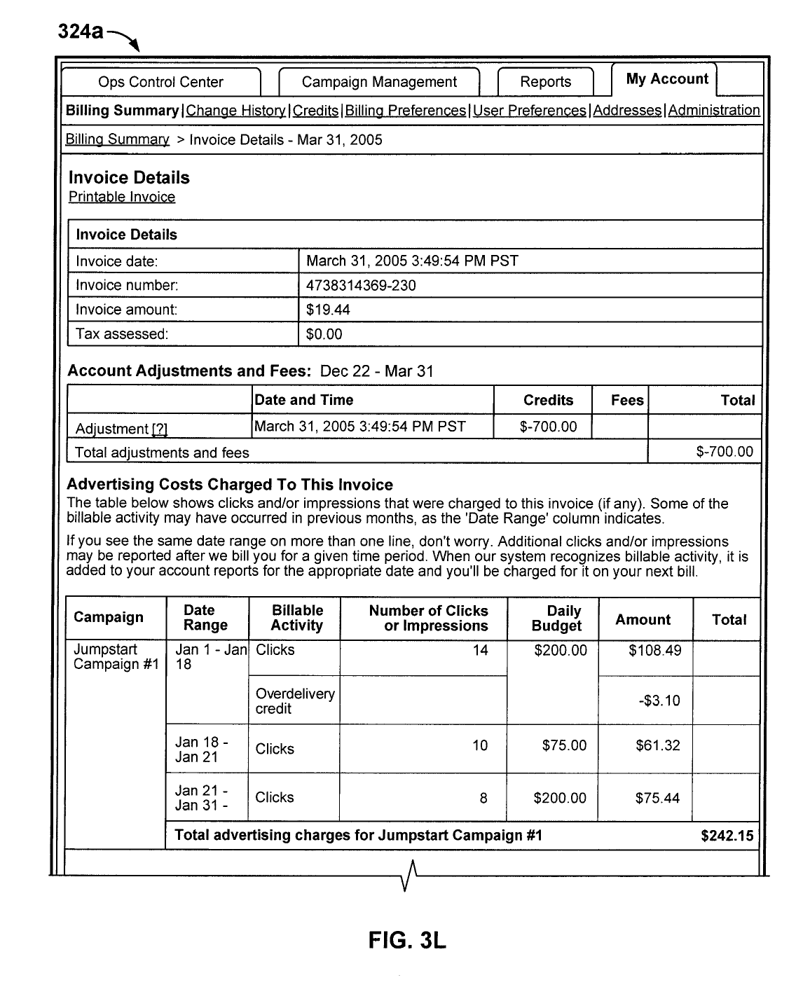

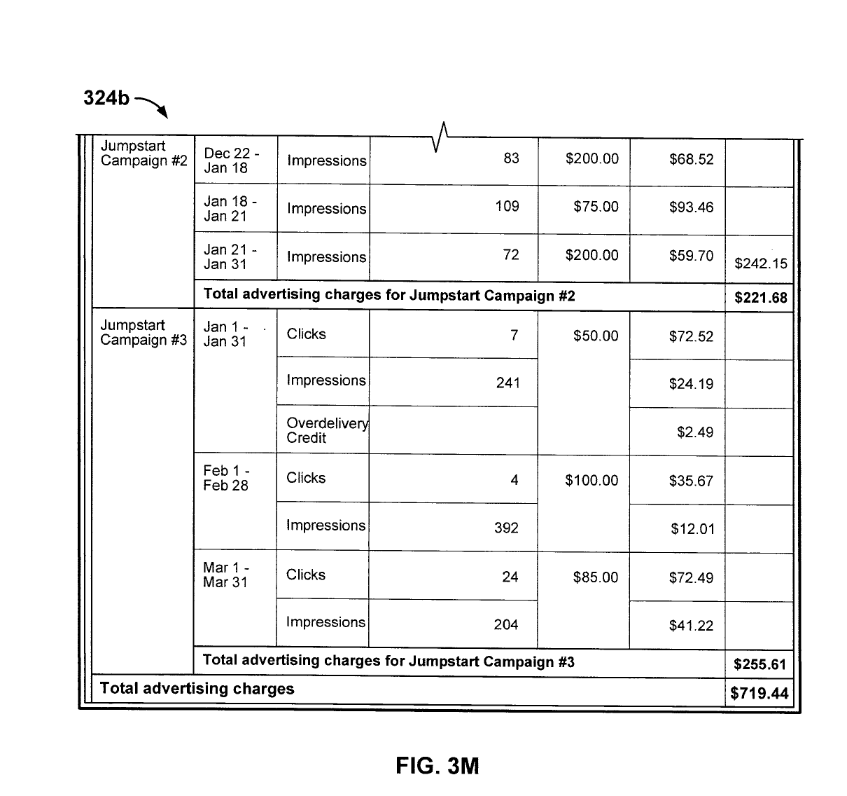

FIGS. 3A-3M illustrate an example user interface for setting up an advertising campaign. FIG. 3A illustrates an example page 302 where an advertiser who wishes to target advertisements by site can find and choose websites to which they can target and place advertisements. In some implementations, an advertiser can find and select sites to target by any of a variety of ways, including, for example, entering specific Universal Resource Locators (URLs) of websites, by entering words or phrases indicating one or more topics, or by browsing through categories of websites.

An advertiser can enter specific URLs to find out if the websites at the entered URLs belong to one or more networks of entities that has agreed to display advertisements (e.g., a search engine network, or a content provider network). If an entered URL does belong to one or more of these networks, then the advertiser may select it for targeting. If an entered URL does not belong to any of the networks, then the advertiser cannot select it for targeting. In some implementations, the URLs of sites similar to those entered by the user and which belong to one or more of the networks are shown to the advertiser, and the advertiser may select one or more of these similar sites for targeting.

The advertiser can also enter one or more words or phrases describing a topic or subject matter. Sites within the networks that match the topic or subject matter are presented to the advertiser, and the advertiser may select one or more of these presented sites for targeting.

The advertiser can select one of a plurality of predefined categories (e.g., “Games,” “Health”). Sites within the networks that belong to the selected category are presented to the advertiser, and the advertiser may select one or more of these presented sites for targeting.

Once the advertiser selects one or more sites for targeting, the advertiser chooses a bidding model for advertisement placements in the selected sites. FIG. 3B illustrates an example page 304 for selecting a bidding model. The advertiser can select a CPC or CPM bidding model. The advertiser, after selecting a bidding model, can modify it later. In some implementations, the bidding model selection page 304 also allows the advertiser to select a mixed (i.e., CPC+CPM) bidding model for site-targeted advertisement placements.

FIGS. 3C-3E illustrate example pages 306, 308, and 310 for entering a bid. After the advertiser selects a bidding model, the advertiser can enter a bid amount. If the advertiser selected a CPC bidding model, the advertiser can enter a maximum CPC the advertiser is willing to pay, as illustrated in page 306. If the advertiser selected a CPM bidding model, the advertiser can enter a maximum CPM the advertiser is willing to pay, as illustrated in page 308, along with a maximum allowable number of impressions per day (to help cap costs). If the advertiser selected a mixed bidding model, the advertiser can enter a maximum CPC and a maximum CPM the advertiser is willing to pay, as illustrated in page 310.

FIG. 3F illustrates an example page 312 for entering one or more keywords for advertisement targeting. The advertiser can also use keyword targeting for their advertisements. If the advertiser chooses to target keywords for their advertisement placements, the advertiser can enter one or more keywords for targeting. In some implementations, keyword suggestions can be provided to the advertiser based on an analysis of a website associated with the advertiser and/or a word entered by the advertiser; keywords related to the word entered by the user or the webpage can be presented to the advertiser as suggestions, and the advertiser can select any of the suggested keywords for targeting.

After the advertiser has entered or selected one or more keywords for targeting, the advertiser can enter a bid. For example, the advertiser can enter a maximum CPC as shown in page 314 in FIG. 3G. In some implementations, the advertiser can select a CPM or a CPC bidding model for keyword-targeted advertisements and enter a maximum CPM or a maximum CPC bid, respectively.

FIG. 3H illustrates an example page 316 for editing the settings of an advertising campaign. The available settings include settings related to keyword targeting. In some implementations, the advertiser can choose to have their advertisements shown when users search in a search engine (and optionally in search boxes located in member sites of the search engine network associated with the search engine) using any of the targeted keywords. In some implementations, the advertiser can also choose to have their advertisements shown in content provider network websites that match any of the targeted keywords (in addition or in lieu of showing advertisements for searches in the search engine network), and also choose to have separate bids for advertisements in the search engine network and advertisements in the content provider network. Further, in some implementations, the advertiser can edit their bidding options for keyword-targeted advertisements and site-targeted advertisements. In particular instances, the advertiser can provide keyword-less site-targeted submissions that use CPC bidding.

FIG. 3I illustrates an example page 318 for editing bidding options. In the bidding options page 318, the advertiser can, for keyword-targeted advertisements, elect to enter bids manually or to have their bids automatically optimized for their budget. For site-targeted advertisements, the advertiser can select to bid by CPC, CPM, or a combination of CPC and CPM. The advertiser can also elect to bid by the maximum price or the average price they are willing to pay. In some implementations, the advertiser can also to elect to bid by CPC, CPM, or a combination of CPC and CPM for keyword-targeted advertisements.

FIG. 3J illustrates an example page 320 where an advertiser can edit their bids. In page 320, the advertiser has, for each ad group, separate bids for site-targeted advertisements, keyword-targeted advertisements that are placed in a search engine network, and keyword-targeted advertisements that are placed in a content provider network (that are site-targeted). The advertiser can enter a bid amount for any of the bids and change the bid type (e.g., between CPC, CPM, and CPC+CPM).

FIG. 3K illustrates an example page 322 for editing site-specific settings for sites targeted by an ad group. The advertiser can enter a default site bid, which applies to a targeted site by default in the absence of a specific bid for that site. The advertiser can enter specific bids for one or more individual targeted sites. The advertisers can also enter a specific destination URL for an individual targeted site. While the default bid and the individual site bids are shown in page 322 as CPC bids, the bids can also be CPM bids or CPC+CPM bids, depending on the bidding type chosen by the advertiser.

FIGS. 3L and 3M illustrate pages 324a-b of an example invoice of advertising charges. The invoice 324a-b shows the billable activities (e.g., bids, impressions, conversions) for one or more advertising campaigns and the charged amounts for the billable activities. If a campaign uses a CPC bidding model, the basic billable activity is clicks and the charged amount is based on a CPC bid (the charged amount is calculated based on a CPC bid and the number of clicks). If a campaign uses a CPM bidding model, the basic billable activity is impressions and the charged amount is based on a CPM bid (the charged amount is calculated based on a CPM bid and the number of impressions). If a campaign uses a CPC+CPM bidding model, the basic billable activities are clicks and impressions and the charged amount is based on a CPC bid and a CPM bid (the charged amount is calculated based on a CPC bid and a number of clicks, and a CPM bid and a number of impressions). For example, “Jumpstart Campaign #1” in FIG. 3L follows the CPC bidding model; the charged amounts are calculated based on clicks. “Jumpstart Campaign #2” in FIG. 3L follows the CPM bidding model; the charged amounts are calculated based on impressions. “Jumpstart Campaign #3” in FIG. 3L follows the CPC+CPM bidding model; the charged amounts are calculated based on clicks and impressions.

In some implementations, when an advertiser creates an advertising campaign (whether site-targeted, keyword targeted, or a mix of both), the advertiser can be asked to choose a bidding model (e.g., CPC, CPM, combinations of CPC and CPM) for the campaign. After the advertiser chooses a bidding model, the advertiser is asked to enter a daily budget and a bid for the campaign in accordance with the chosen bidding model.

In some implementations, the advertiser can choose a bidding model and enter a daily budget and a bid for an ad group within an advertising campaign. After the advertiser chooses a bidding model, the advertiser is asked to enter a daily budget and a bid for the ad group in accordance with the chosen bidding model.

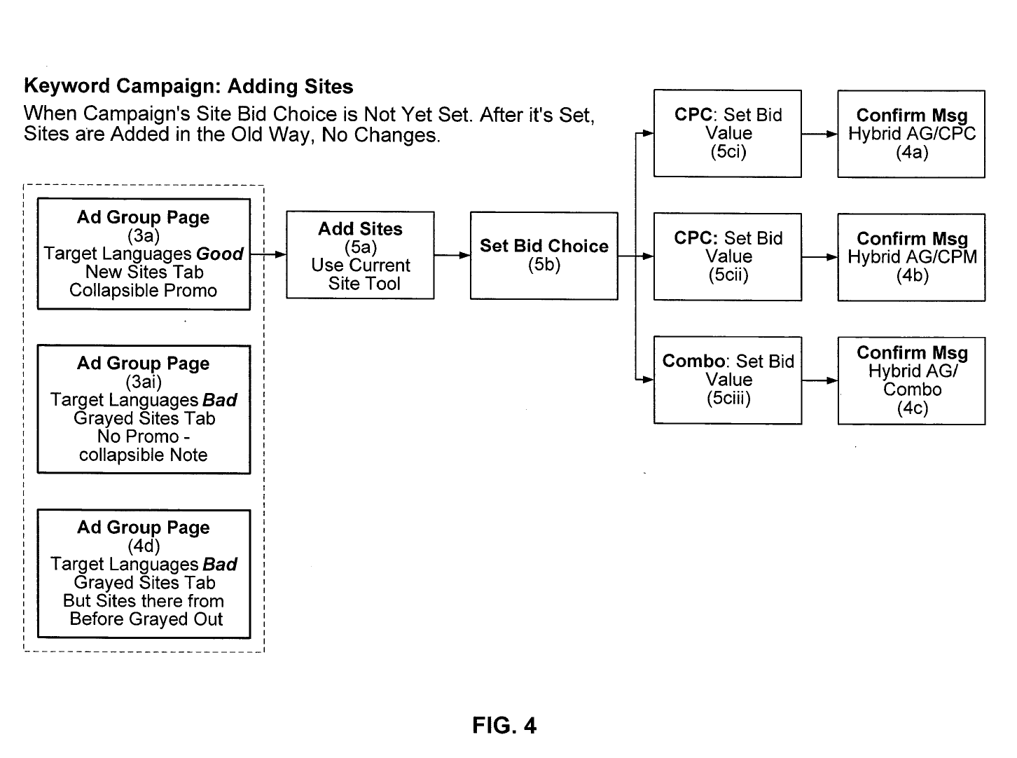

FIG. 4 is a block diagram of example steps for adding web sites to a targeted ad campaign. The flow of the diagram starts with three ad group pages, and may be used where a user has not yet selected a particular site or sites to targeted with their ads. At an “add sites” box, the user may be given an opportunity to select particular sites at which they would like the ads to be displayed, in manners like those described above. The user may them be asked to set a bid choice or choices for the ads. Depending on the type of bid selected, the user may be asked to set a CPC value, a CPM value, or a combo (CPC+CPM) value. Finally, the system may provide a confirmatory message to the advertiser summarizing the information selected with respect to each advertisement, and may provide the advertiser with an opportunity to change or update such information.

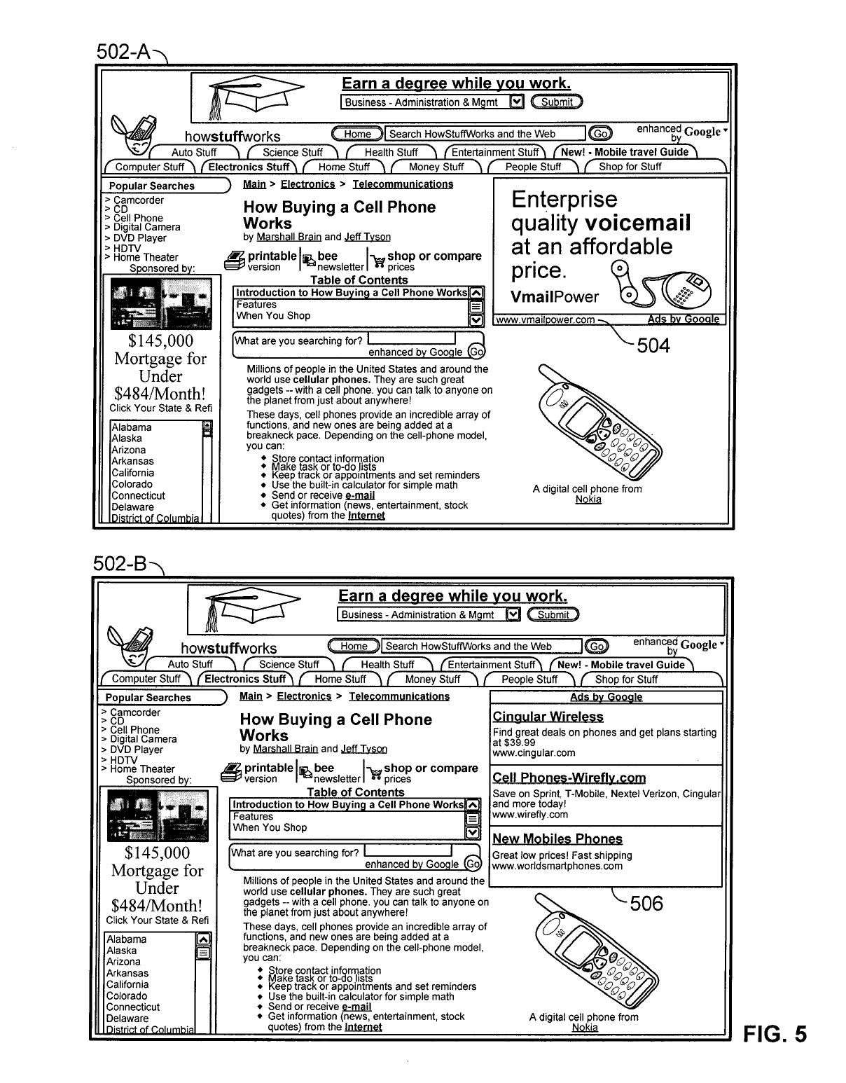

FIG. 5 illustrates two example webpages with advertisement placements. Webpages 502-A and 502-B includes an advertisement display region on the right side. In webpage 502-A, the advertisement display region is occupied by a single display advertisement 504. Examples of display advertisements include image advertisements and an advertisements using Adobe® Flash®. In webpage 502-B, the advertisement display region is occupied by multiple text advertisements 506. Each of the text advertisements takes up less than the whole region; the advertisement display region can be filled with multiple text advertisements.

The fact that an advertisement can take up the entirety or less than the entirety of an advertisement display region can affect the requirements for getting placement of an advertisement, as described below. For example, if the bids from the ads in webpage 502-B are 2, 1, and 2, then the bid for the ad in webpage 502-A would presumably need to be more than 5, or the relevance of the advertisement would need to be higher (or perhaps much higher) than the combined or average relevance of the advertisements on webpage 502-B.

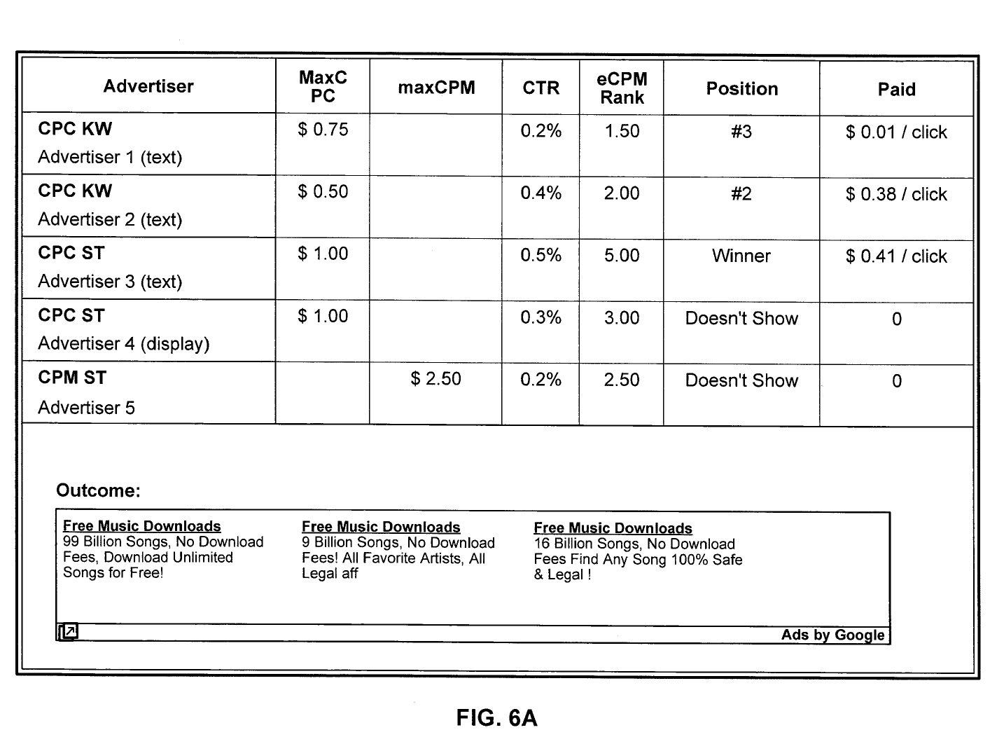

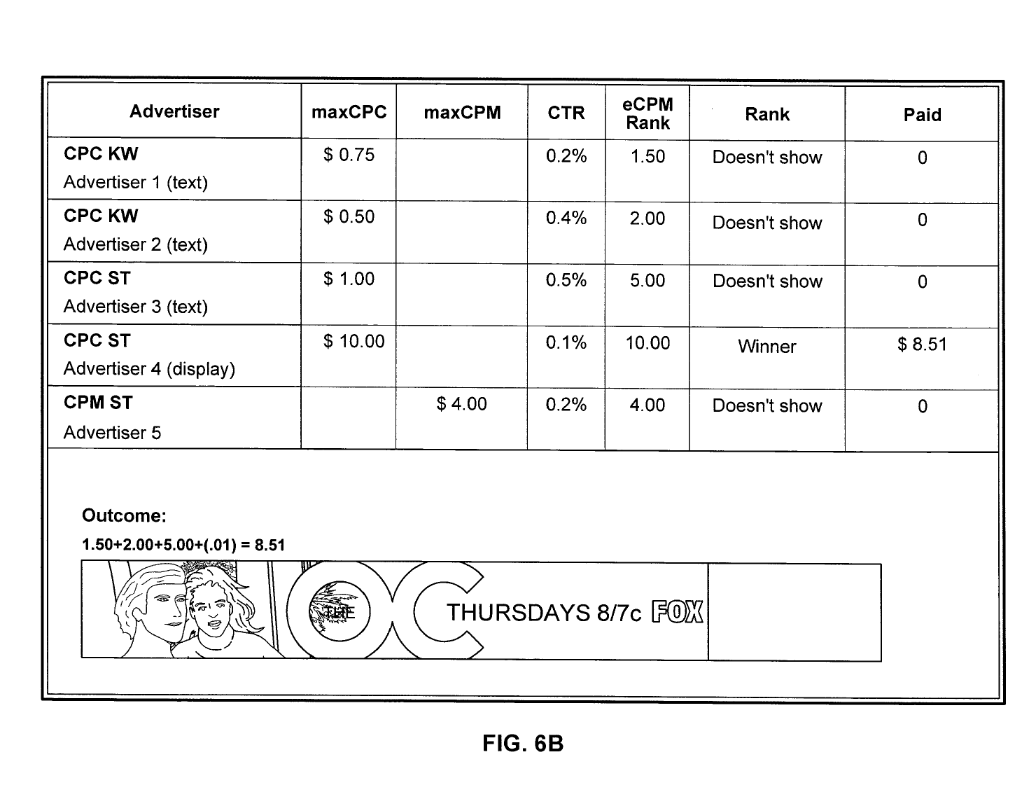

FIGS. 6A and 6B illustrate two example advertisement auctions and their outcomes. The auctions provide examples for pitting ads having different payment mechanisms against each other. In FIG. 6A, five advertisers bid for placement in an advertisement display region. Advertiser 1 places a CPC bid of $0.75 for a keyword-targeted text advertisement. Advertiser 2 places a CPC bid of $0.50 for a keyword-targeted text advertisement. Advertiser 3 places a CPC bid of $1.00 for a site-targeted text advertisement. Advertiser 4 places a CPC bid of $1.00 for a site-targeted display advertisement. Advertiser 5 places a maximum CPM bid of $2.50 for a site-targeted advertisement. Each of the ads may or may not be site-targeted.

The winner of the bid is determined by converting CPC bids in the auction to an eCPM (“estimated CPM”) level and comparing them to CPM bids. A CPC bid is converted to an eCPM by multiplying the CPC bid by the click-through rate (CTR) and 1000. In the auction shown in FIG. 6A, the winner of the auction is Advertiser 3, and thus its advertisement gets the first position within the advertisement display region (as shown at the bottom of FIG. 6A). Because the advertisement for Advertiser 3 is a text advertisement that leaves additional space in the advertisement display region for additional text advertisements, the second and third place bids (Advertiser 2 and Advertiser 1, respectively) also get their text advertisements placed within the advertisement display region. The advertisements for Advertisers 4 and 5 are not shown.

FIG. 6B shows an example auction where an advertiser whose display advertisement, which takes up sufficient space in the advertisement display region to exclude other advertisements from placement, wins the auction. In the auction shown in FIG. 6B, Advertiser 4 has a $10.00 CPC bid, which is converted to a eCPM of 10.00 and wins the auction as the largest eCPM. Because the winning advertisement is a display advertisement that takes up sufficient space in the advertisement display region to exclude other advertisements from placement, none of the other advertisements in the auction are shown. The price paid by the winning Advertiser 4 is the sum of the next three highest bids for text advertisements and a minimum bid amount (which, in some implementations, is $0.01).

In the example auctions shown in FIGS. 6A-6B, site-targeted advertisements can compete with keyword-targeted advertisements in the same auction for placement. Further, as illustrated by the example auctions, a display advertisement that takes up all the ad slots, in order to be placed and displayed, must win the auction. On the other hand, text advertisements that do not win the auction may still be displayed.

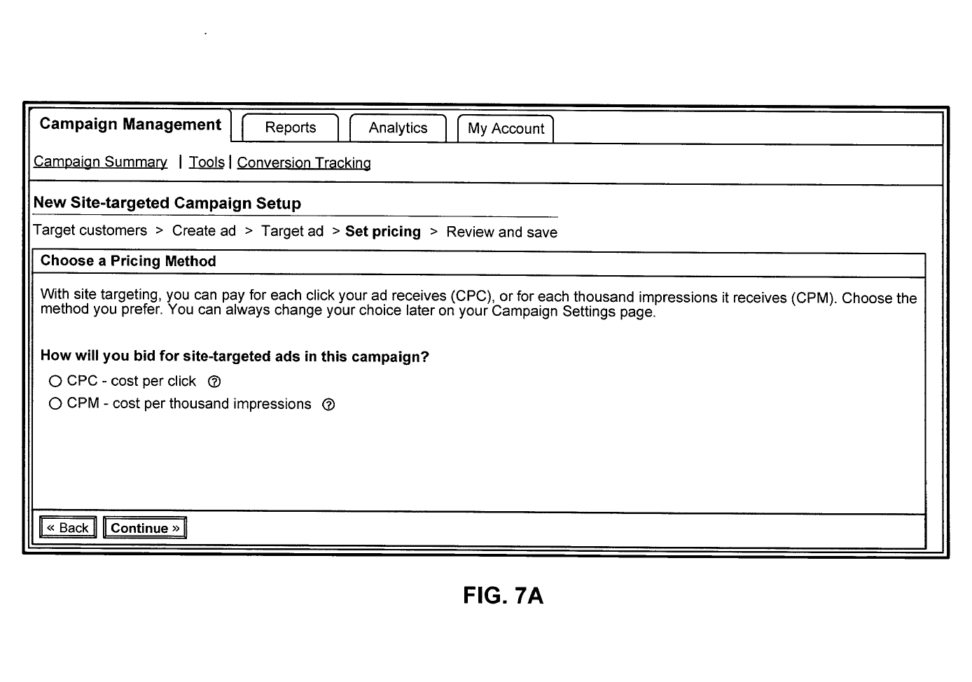

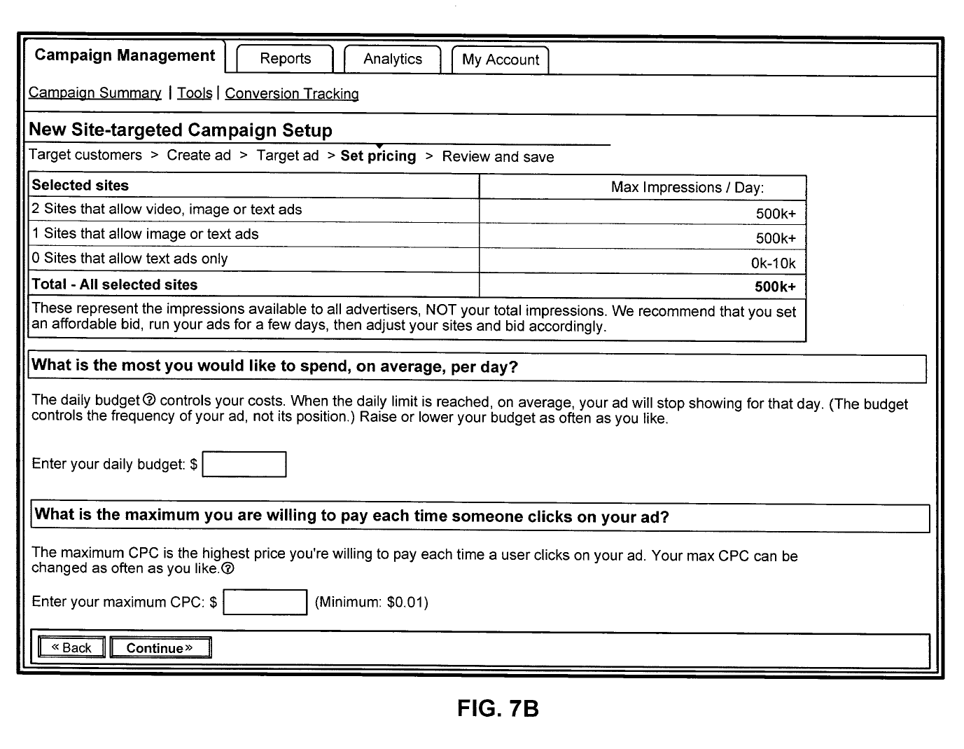

FIGS. 7A-7B illustrate example pages for selecting a bidding model and entering a bid for a newly created advertising campaign. FIG. 7A shows an example page where an advertiser creating a new campaign can select a bidding model from amongst CPC and CPM. In some implementations, the choices for the bidding model also includes a CPC+CPM combination. After the advertiser selects a bidding model, the advertiser can enter a daily budget and a maximum bid in accordance to the selected bidding model, as shown in FIG. 7B.

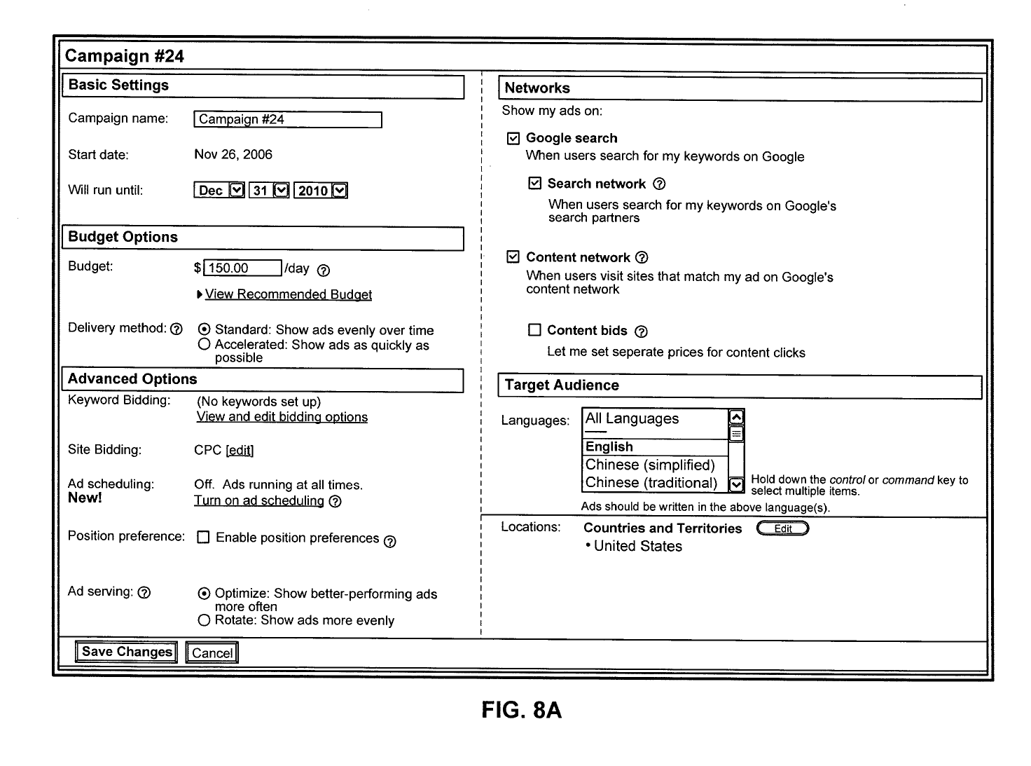

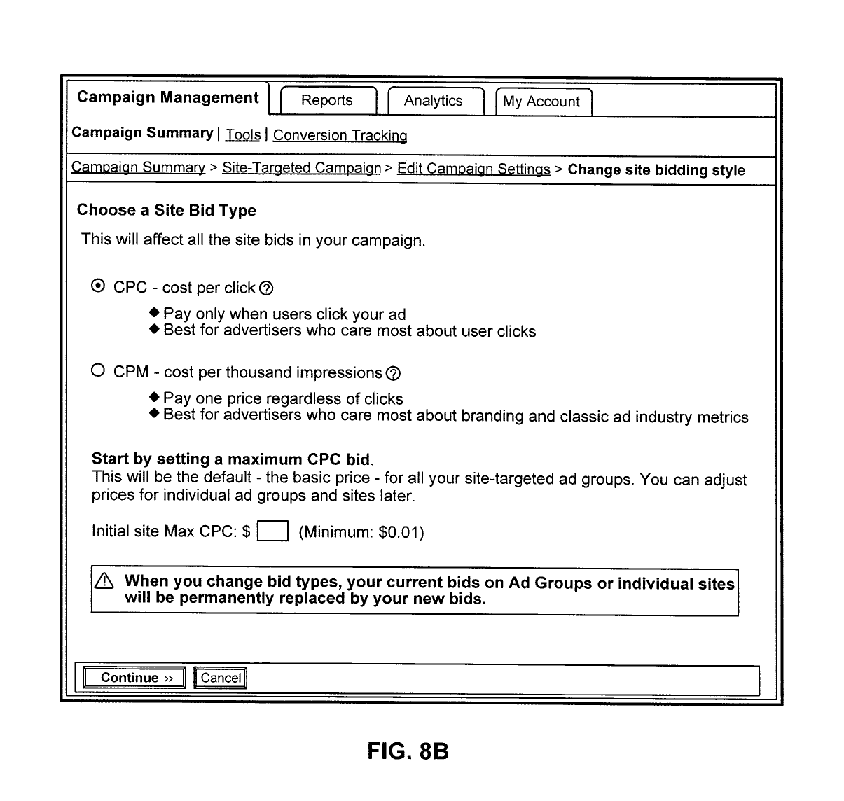

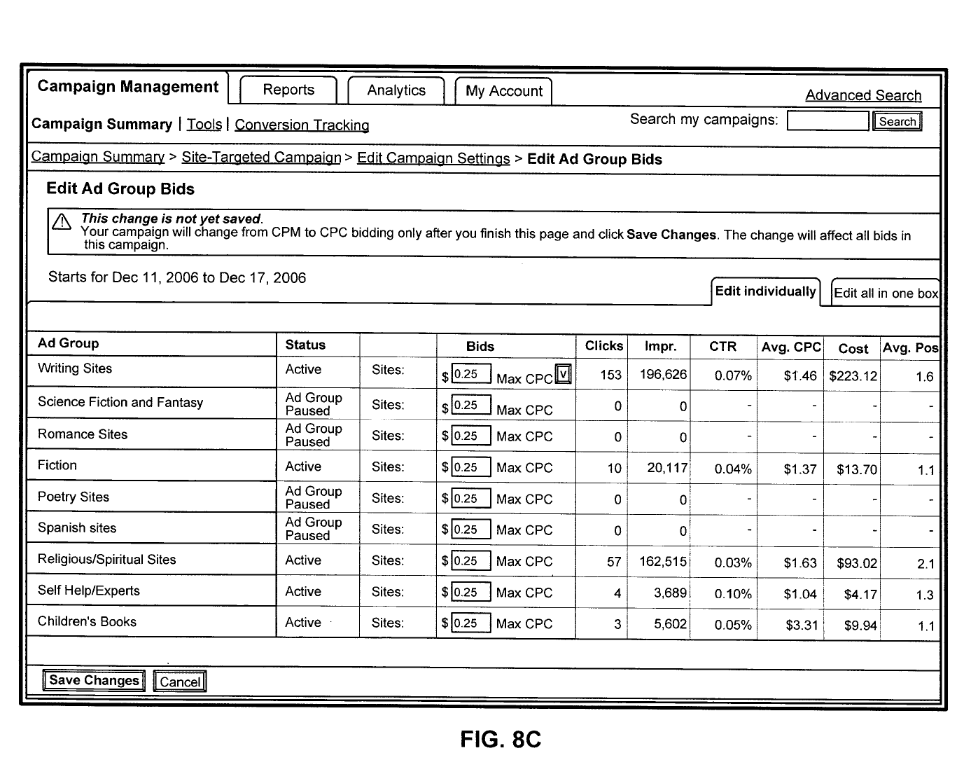

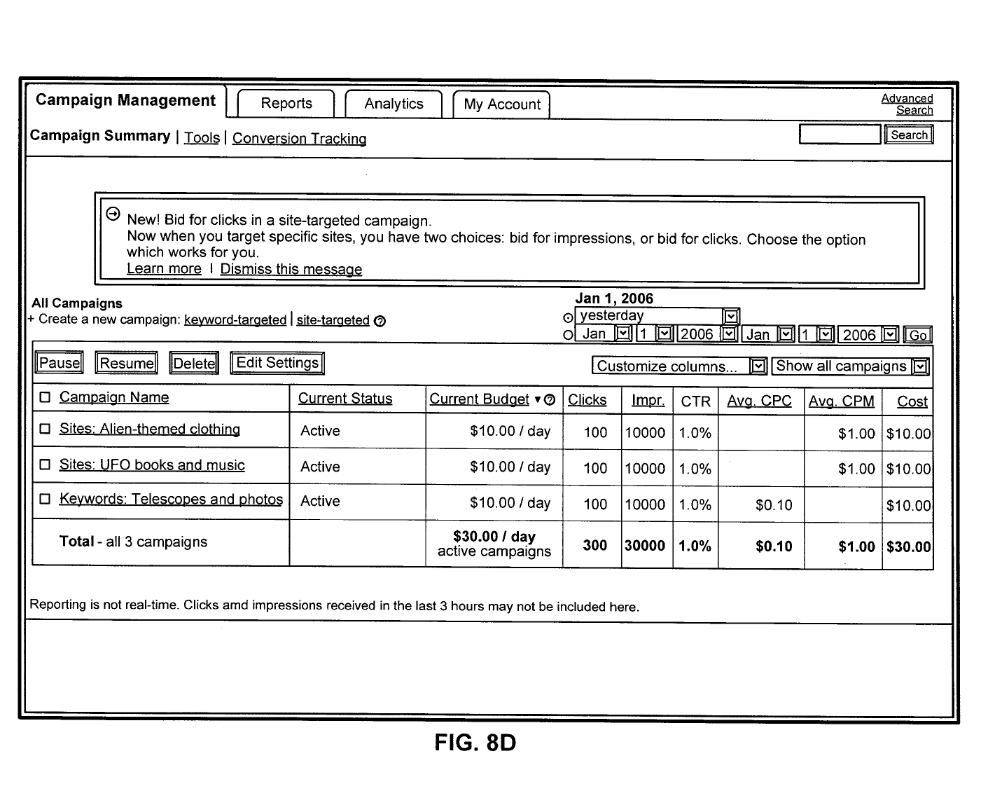

FIGS. 8A-8D illustrate example pages for changing bidding models in an existing advertisement campaign. FIG. 8A shows an example advertising campaign settings page. From within the page, the advertiser can choose to change the bidding model for site-targeted advertisements within the campaign. If the advertiser chooses to change the bidding model, the advertiser can be taken to a page as shown in FIG. 8B, where the advertiser can choose a bidding model and enter a default bid for site-targeted ad groups within the campaign. The advertiser can also enter bids for each of the ad groups within the campaign, as shown in FIG. 8C.

FIG. 8D shows an example details page for an advertising campaign. The page can include a message to the advertiser, alerting the advertiser that they can bid using the CPC model for site-targeted ad groups.

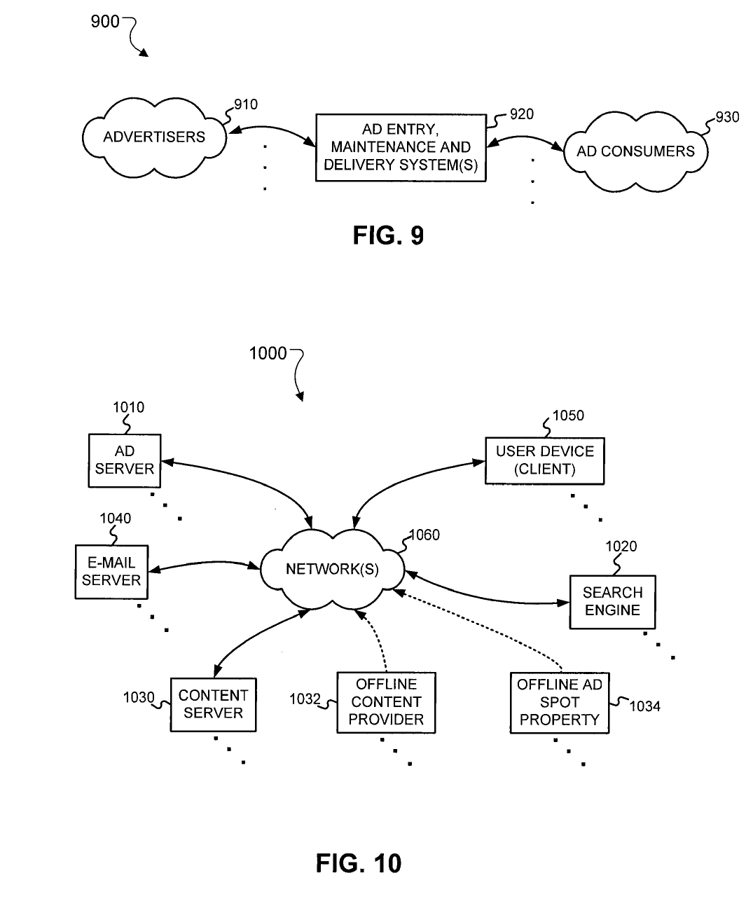

FIG. 9 illustrates an example advertising environment 900. The environment 900 may include an ad entry, maintenance, and delivery system (simply referred to as an ad server) 920. Advertisers 910 may directly, or indirectly, enter, maintain, and track ad information in the system 920. The ads may be in the form of graphical ads such as so-called banner ads, text only ads, image ads, audio ads, video ads, ads combining one of more of any of such components, etc. The ads may also include embedded information, such as a link, and/or machine executable instructions. Ad consumers 930 may submit requests for ads to, accept ads responsive to their request from, and provide usage information to, the system 920. An entity other than an ad consumer 930 may initiate a request for ads. Although not shown, other entities may provide usage information (e.g., whether or not a conversion or selection related to the ad occurred) to the system 920. This usage information may include measured or observed user behavior related to ads that have been served.

The ad server 920 may be similar to the one described above. An advertising program may include information concerning accounts, campaigns, creatives, targeting, etc. The term “account” relates to information for a given advertiser (e.g., a unique e-mail address, a password, billing information, etc.). A “campaign,” “advertising campaign,” or “ad campaign” refers to one or more groups of one or more advertisements, and may include a start date, an end date, budget information, targeting information, syndication information, etc.

For example, Honda may have one advertising campaign for its automotive line, and a separate advertising campaign for its motorcycle line. The campaign for its automotive line may have one or more ad groups, each containing one or more ads. Each ad group may include targeting information (e.g., a set of keywords, a set of one or more topics, a set of one or more websites, etc.), and price information (e.g., cost, average cost, or maximum cost (per impression, per selection or click, per conversion, etc.)). Therefore, a single cost, a single maximum cost, and/or a single average cost may be associated with one or more keywords, and/or topics.

As stated, each ad group may have one or more ads or “creatives” (That is, ad content that is ultimately rendered to an end user.). Each ad may also include a link to a URL (e.g., a landing Web page, such as the home page of an advertiser, or a Web page associated with a particular product or server). The ad information may include more or less information, and may be organized in a number of different ways.

FIG. 10 illustrates an example advertising environment 1000. A user device (also referred to as a “client” or “client device”) 1050 may include a web browser, an e-mail application, etc. A search engine 1020 may permit user devices 1050 to search collections of documents (e.g., Web pages). A content server 1030 may permit user devices 1050 to access documents. An e-mail server 1040 may be used to provide e-mail functionality to user devices 1050. An ad server 1010 may be used to serve ads to user devices 1050. The ads may be served in association with search results provided by the search engine 1020. However, content-relevant ads may be served in association with content provided by the content server 1030, and/or e-mail supported by the e-mail server 1040 and/or user device e-mail facilities.

Ads may be targeted to particular sites. In addition, ads may be targeted to documents served by content servers. Thus, one example of an ad consumer 130 is a general content server 1030 that receives requests for documents (e.g., articles, discussion threads, music, video, graphics, search results, Web page listings, etc.), and retrieves the requested document in response to, or otherwise services, the request. The content server may submit a request for ads to the ad server 1010. Such an ad request may include a number of ads desired. The ad request may also include document request information. This information may include the document itself (e.g., page), a category or topic corresponding to the content of the document or the document request (e.g., arts, business, computers, arts-movies, arts-music, etc.), part or all of the document request, content age, content type (e.g., text, graphics, video, audio, mixed media, etc.), geo-location information, document information, etc.

The content server 1030 may combine the requested document with one or more of the advertisements provided by the ad server 1010. This combined information including the document content and advertisement(s) is then forwarded towards the end user device 1050 that requested the document, for presentation to the user. Finally, the content server 1030 may transmit information about the ads and how, when, and/or where the ads are to be rendered (e.g., position, selection or not, impression time, impression date, size, conversion or not, etc.) back to the ad server 1010. Alternatively, or in addition, such information may be provided back to the ad server 1010 by some other means.

The offline content provider 1032 may provide information about ad spots in an upcoming publication, and perhaps the publication (e.g., the content or topics or concepts of the content), to the ad server 1010. In response, the ad server 1010 may provide a set of ads relevant the content of the publication for at least some of the ad spots. Examples of offline content providers 1032 include, for example, magazine publishers, newspaper publishers, book publishers, offline music publishers, offline video game publishers, a theatrical production, a concert, a sports event, etc.

Owners of the offline ad spot properties 1034 may provide information about ad spots in their offline property (e.g., a stadium scoreboard banner ad for an NBA game in San Antonio, Tex.). In response, the ad server may provide a set of ads relevant to the property for at least some of the ad spots. Examples of offline properties 1034 include, for example, a billboard, a stadium score board, and outfield wall, the side of truck trailer, etc.

Another example of an ad consumer 130 is the search engine 1020. A search engine 1020 may receive queries for search results. In response, the search engine may retrieve relevant search results (e.g., from an index of Web pages). Such search results may include, for example, lists of Web page titles, snippets of text extracted from those Web pages, and hypertext links to those Web pages, and may be grouped into a predetermined number of (e.g., ten) search results.

The search engine 1020 may submit a request for ads to the ad server 1010. The request may include a number of ads desired. This number may depend on the search results, the amount of screen or page space occupied by the search results, the size and shape of the ads, etc. In some implementations, the number of desired ads is from one to ten. In an exemplary implementation, the number of desired ads is from three to five.

The request for ads may also include the query (as entered or parsed), information based on the query (such as geolocation information, whether the query came from an affiliate and an identifier of such an affiliate), and/or information associated with, or based on, the search results. Such information may include, for example, identifiers related to the search results (e.g., document identifiers or “docIDs”), scores related to the search results (e.g., information retrieval (“IR”) scores such as dot products of feature vectors corresponding to a query and a document, relevance scores, and/or combinations of IR scores and relevance scores), snippets of text extracted from identified documents (e.g., Web pages), full text of identified documents, topics of identified documents, feature vectors of identified documents, etc.

The search engine 1020 may combine the search results with one or more of the advertisements provided by the ad server 1010. This combined information including the search results and advertisement(s) is then forwarded towards the user that submitted the search, for presentation to the user. Preferably, the search results are maintained as distinct from the ads, so as not to confuse the user between paid advertisements and presumably neutral search results.

The search engine 1020 may transmit information about the ad and when, where, and/or how the ad was to be rendered (e.g., position, selection or not, impression time, impression date, size, conversion or not, etc.) back to the ad server 120/1010. Alternatively, or in addition, such information may be provided back to the ad server 120/1010 by some other means.

The components described above can be interconnected by one or more networks 1060. The one or more networks 1060 can include, for example, local area networks, wide area networks, wireless networks, Wi-Fi networks, mobile phone networks, and the Internet. Although the foregoing examples described servers as (i) requesting ads, and (ii) combining them with content, one or both of these operations may be performed by a client device (for example, an end user computer).

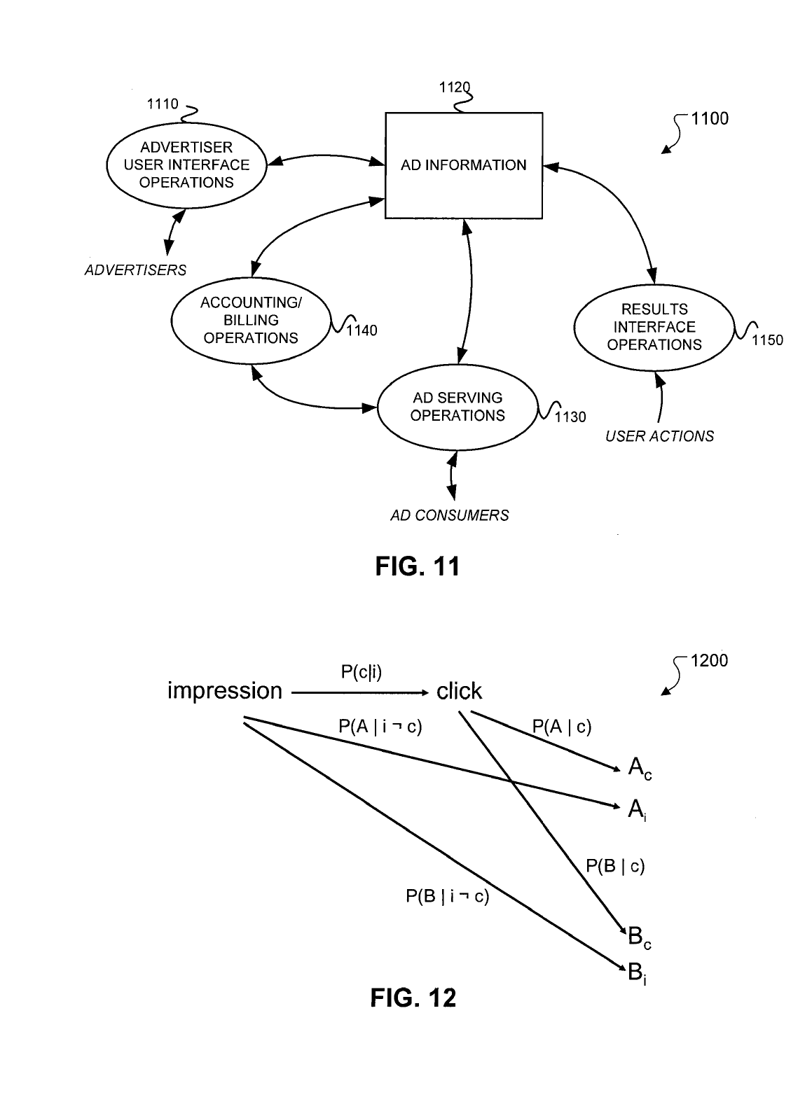

FIG. 11 is a bubble diagram 1100 illustrating example operations in an advertising environment. The operations include, for example, advertiser user interface operations 1110, ad serving operations 1120, accounting and billing operations 1140 and results interface operations 1150. The information may include ad information 1120.

Advertiser user interface operations 1110 may be used to allow advertiser to interact with the advertising network. For example, advertisers can enter and manage ad information 1120 via the advertiser user interface operations 1110. Campaign (e.g., targeting) assistance operations (not shown) can be employed to help advertisers generate effective ad campaigns.

Ad consumers (e.g., search engines 1020, content servers 1030, offline content providers 1032, offline ad spot property owners 1034 and/or email servers 1040) may interface with the advertising network via the ad serving operations 1130. The ad serving operations 1130 may service requests for ads from such ad consumers. The ad serving operations 1130 may determine relevant candidate ads for a given request. The ad serving operations 1130 may then score those ads to determine a final set of one or more of the candidate ads, as well as presentation attributes of such ads (e.g., placement, treatments, etc.)

Ad consumers and/or users may also interface with the advertising network via results interface operations 1150. The results interface operations 1150 may be used to accept information about user actions (such as whether or not a click-through occurred, whether or not a conversion occurred, etc.) Such user action information may include information to identify the ad and time the ad was served, as well as the associated result.

Accounting/billing operations 1140 may be used to determine compensation due to the ad network (and perhaps some additional parties, such as content owners, ad spot property owners, etc.) from the advertisers.

The ad information 1120 may include one or more of ad account information, ad performance information, advertiser account information, etc. For example, an advertising program may include information concerning accounts, campaigns, creatives, targeting, etc. The term “account” relates to information for a given advertiser (e.g., a unique email address, a password, billing information, etc.). A “campaign” or “ad campaign” refers to one or more groups of one or more advertisements, and may include a start date, an end date, budget information, geo-targeting information, syndication information, etc.

For example, Honda may have one advertising campaign for its automotive line, and a separate advertising campaign for its motorcycle line. The campaign for its automotive line may have one or more ad groups, each containing one or more ads. Each ad group may include various targeting information (referred to as “serving constraints”) and associated offer. Each ad group may have one or more ads or “creatives” (That is, ad content that is ultimately rendered to an end user.). Each ad or ad group may be associated with one or more landing pages. An ad may be associated with a landing page using a link, such as a hyper-text link for example, to a URL of the landing page. Naturally, the ad information may include more or less information, and may be organized in a number of different ways.

The ad information 1120 may also include account balance information. This information may be updated based on advertiser payments and/or receivables determined by accounting/billing operations 1140.

As mentioned above, the ad information 1120 may also include ad performance information. This information may be updated based on user actions (impressions, selections, conversions, etc.) received by the results interface operations 1150.

In some implementations, different advertisers with different value propositions can express those value propositions directly (e.g., in terms of offers to an advertising network). Advertisers can choose to interact with an ad network by sharing their value proposition at different levels of specificity. A high level of specificity may correspond directly with an advertiser's ultimate end goals, whatever they may be. Less specificity may correspond to more complex, subtle, or less-understood value propositions to the advertiser. Advertisers may select, for example to have their ads be site-targeted and to use or not use keyword for selection of their ads. Auctions may include both types of advertisers and may compare their respective bids and popularity to determine a highest scoring advertiser.

An advertiser may use conversion-tracking to indicate that a user purchased a book from their affiliate Website resulting in a 15% commission on the price of the book—this is a highly specific value proposition. In contrast, an automobile advertiser may be interested in impressions of a BMW creative which it believes will enhance its brand and will therefore ultimately benefit the company in a subtle way that is hard to measure but that ultimately results in value—this coupling of the advertiser's value proposition to impressions is very non-specific. In the case of non-specific value propositions, advertisers may not fully understand their value-proposition. Even if an advertiser has good data on the probability of a valued event (e.g., a conversion), it may prefer to keep those data private and not share it with an advertising network.

An implementation may use some notion of the value of an event, as expressed by an advertiser, as well as a probability of that event occurring. FIG. 12 illustrates different notions of advertiser value and how they can be determined. FIG. 12 illustrates four different events—impression, click, and two advertiser-defined events (A and B). The impression and click events are both “immediate” (the ad serving system measures them directly), while the A and B events are both “deferred” (the advertiser needs to report them to the advertising network in order for the ad network to know about them). The event A (and similarly for event B) can occur via two different ways: Aᵢ and A_{c}. Aᵢ occurs due to an impression only (no click). That is, under event Aᵢ, the user received the ad impression, did not select the ad, but nonetheless had the desired behavior. A_{c} occurs only after an ad is selected (clicked). That is, the user received the ad impression, clicked on the ad, and then had the desired behavior. The value to the advertiser of the event A will often be independent of whether the event was via impression only, or via impression and selection. To state it differently, typically to the advertiser, the value of Aᵢ=A_{c}. Thus, to the extent that an advertiser specifies offers for specific events, the value of the events should be independent of how the event occurred.

In FIG. 12 and the following description, when used in the context of a probability, the symbol “|” denotes a conditional probability and the symbol [symbol] denotes negation. The edges in FIG. 12 are annotated with the probabilities of a user taking actions corresponding to the event. For example, on the edge from “impression” to “click” is the probability of a click given an impression (P(c|i)). This probability can be referred to as the click-through-rate (CTR). The two edges leading to event B are the probability of event B given a click (P(B|c)) and given only an impression (P(B|i [symbol] c)). Note that P(B|c)>P(B|i) because the occurrence of a click implies the occurrence of an impression (and the inequality is strict iff P(c|i)<1). Furthermore, it is generally expected that P(B|i [symbol] c)<P(B|c), though it is possible for P(B|i [symbol] c)>P(B|c) (For example, a great creative that targets a poor landing page (e.g., a server-down or an offensive site) could result in better advertiser-defined conversions for users who only saw the ad but did not click it.).

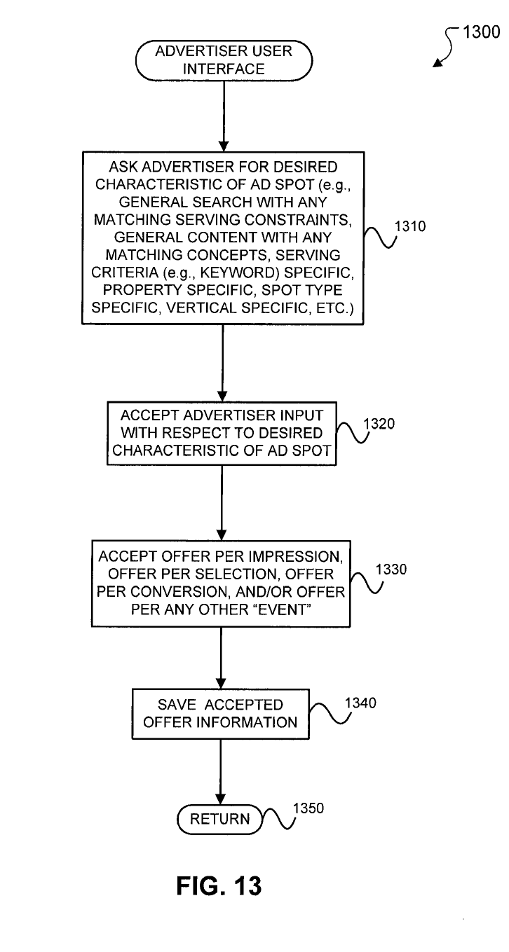

FIG. 13 is a flow diagram of an example process 1300 for providing an advertiser user interface. As shown, an advertiser may be asked (e.g., via an input display screen) for a desired characteristic of an ad spot (1310). The advertiser input with respect to a desired characteristic of an ad spot is then accepted (1320), as is one or more offers for an event (e.g., impression, selection, conversion, etc.) related to the ad spot (1330). The accepted offer information is then saved (1340) before the process 1300 is left (1350).

Referring back to block 1310, the desired characteristic of an ad spot may be, for example, (A) an ad spot returned with a search result page in which any targeting criteria of the ad are met, (B) an ad spot returned with a search result page in which a particular targeting criteria of the ad is met, (C) an ad spot on a content page with a concept matching any targeting concepts of the ad, (D) an ad spot on a content page with a concept matching a particular targeting concept of the ad, (E) an ad spot on a specific (e.g., online or offline) property, (F) an ad spot in a specific vertical, (G) a specific type of ad spot type (e.g., animation only, video only, etc.), etc.

Referring back to block 1320, more than one desired ad spot characteristic may be entered by the advertiser. In such a case, the acts of blocks 1330 and 1340 may be repeated for each desired as spot characteristic entered. Advertisers may also select, for example, to have certain site-targeted ads selected at least in part based on keywords while others may select to supply no keywords (and have their ad selected without regard to keywords at all or with regard only to keywords selected by the system, such as keywords taken from an ad creative or from a landing page (or an associated and related group of pages, or a domain) associated with the ad.

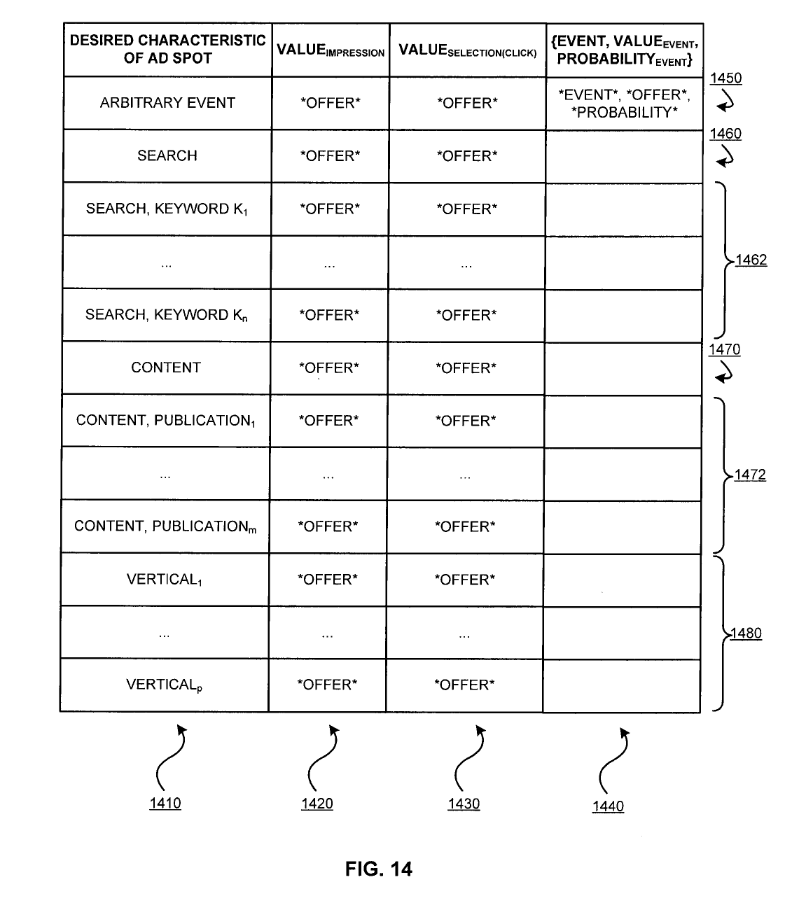

FIG. 14 is an example template 1400 through which an advertiser can specify desired ad spot characteristics and enter different types of offers. This template 1400 allows advertisers to provision offers (e.g., bids) that represent and track their value closely, even as independent factors beyond their control (e.g., CTR and other conversion rates) change. The template 1400 includes a desired characteristic of ad spot column 1410, a value per impression column 1420, a value per selection (e.g., click) column 1430, and a column 1440 for entering arbitrary events, values per event, and probability of such an event.

In some implementations, the first row 1450 of the template 1400 is sufficient to capture the entire value proposition for advertisers. In some other implementations, advertisers are not given an opportunity to report impression-to-conversion rates. Such implementations may allow advertisers to specify per-impression offers. Furthermore, because many advertisers may not wish to enable conversion tracking, some implementations may allow advertisers to input offer information (e.g., allow some server-side provisioning of offers per selection).

Search row 1460 may be used to accept an advertiser's baseline offer(s). The values of offers for specific serving constraints (e.g., keywords) (rows 1462) may be populated to be the same by default, but can be separately changed by the advertiser. Similarly, content row 1470 may be used to accept an advertiser's baseline offer(s). The values of offers for specific publications (e.g., specific websites) (rows 1472) may be populated to be the same by default, but can be separately changed by the advertiser. In some implementations, the content default offer(s) are required to be some minimum value if any publications have offers (i.e., the advertiser either needs a content default offer above the minimum, or it needs to be opted out of content). In some other implementations, this requirement is relaxed to allow advertisers to run only on publications that they specifically mention and make an offer on.

Referring to rows 1462, offers per impression, and/or selection corresponding to specific keywords (or some other serving constraints) may be accepted. In some implementations, these rows are used only for search advertising.

Referring to rows 1472, offers per impression, and/or selection corresponding to specific publications (e.g., Website) may be accepted. Similarly, referring to rows 1480, offers per impression, and/or selection corresponding to specific verticals (For examples of “verticals,” see, e.g., U.S. Patent Application Publication No. 2006/0242147 (incorporated herein by reference), filed on Apr. 22, 2005, titled “CATEGORIZING OBJECTS, SUCH AS DOCUMENTS AND/OR CLUSTERS, WITH RESPECT TO A TAXONOMY AND DATA STRUCTURES DERIVED FROM SUCH CATEGORIZATION”) may be accepted. In some implementations, publications are considered more specific than verticals. In some implementations, these rows 1472, 1480 are used only for contextual advertising.

As can be appreciated from the foregoing, the template 1400 allows advertisers to separately value selections (e.g., clicks) between content and search. The feature is advantageous in implementations where advertisers are not using conversion tracking. This is because advertisers may want some way of making explicit the differential deferred conversion probabilities of events that they are not willing to share with the advertising network. For example, WINZIP may choose to offer $0.40 for content selections and $0.60 for search selections to reflect that it has data that shows a higher conversion rate for selections from search advertising. Each offer may reflect two value components—(1) the specific value of getting a user to the ad landing page, which corresponds to the value of a selection (V_{selection}), and the pro-rated value of a deferred private conversion event (P_{conversion event}*V_{conversion event}). By aggregating these two value components into a single per-click bid, the ad network is unable to properly “smart price” (see, e.g., U.S. Patent Application Publication No. 2006/0004628 (incorporated herein by reference), filed on Jun. 30, 2004, titled “ADJUSTING AD COSTS USING DOCUMENT PERFORMANCE OR DOCUMENT COLLECTION PERFORMANCE”) this offer. This is because smart pricing might only discount the first component, but not the second component, since the second component already represents advertiser value accurately. In some implementations, discounting an offer reflecting both components would be undesirable.

This can be accounted for in three ways. In some implementations, smart pricing is eliminated. In some other implementations, advertisers are allowed to indicate whether the V_{selection} component should be smart-priced. In some further implementations, separate bids for the smart-priced and non-smart-priced click values are collected. The set of implementations in which smart pricing is eliminated is advantageous in its simplicity. This should not be a problem since advertisers are able to enter separate offers for different content (recall, e.g., rows 1472 of FIG. 14.) Moreover, allowing the advertiser to enter offers for arbitrary events (recall, e.g., row 1450 of FIG. 14.) may do a better job than smart-pricing.

Referring back to rows 1462, the template 1400 further supports incremental per-keyword (or some other serving constraint) offers on specific search keywords. In some implementations, this offer may replace the “baseline” search offer (row 1460). In some other implementations, the per-keyword offers are added to the baseline search offer (and can be thought of as incremental value offers) instead of replacing the baseline search offer.

In addition to allowing advertisers to make specialized selection offers, the template 1400 also allows advertisers to make offers corresponding to specialized values associated with different types of impressions. For example, the template 1400 allows different offers for search impressions and content impression, as well as incremental offers per keyword, per content, per vertical, etc. These are most simply understood as extra value that the advertiser offers to represent their desire for placement with certain search results pages, or on certain publications (e.g., Websites) (e.g., because the deferred conversions are higher for such keywords, publications, verticals). Note also that allowing advertisers to make per-publication differential offers has the additional benefit of attracting the best publishers to participate in the ad network.

The advertiser user interface can have more or less options for the advertiser to express their value of events (e.g., in terms of an offer) than those shown in template 1400. For example, the user interface may be much simpler, perhaps beginning with a choice among several of the most common advertiser desires (e.g., “Do you want impressions, selections, value-based bidding, or an advanced interface”). In some implementations, each of the options may then have a user interface (e.g., a different template) tuned to how different segments of advertisers may value different events (or value simplicity of interacting with the advertising system).

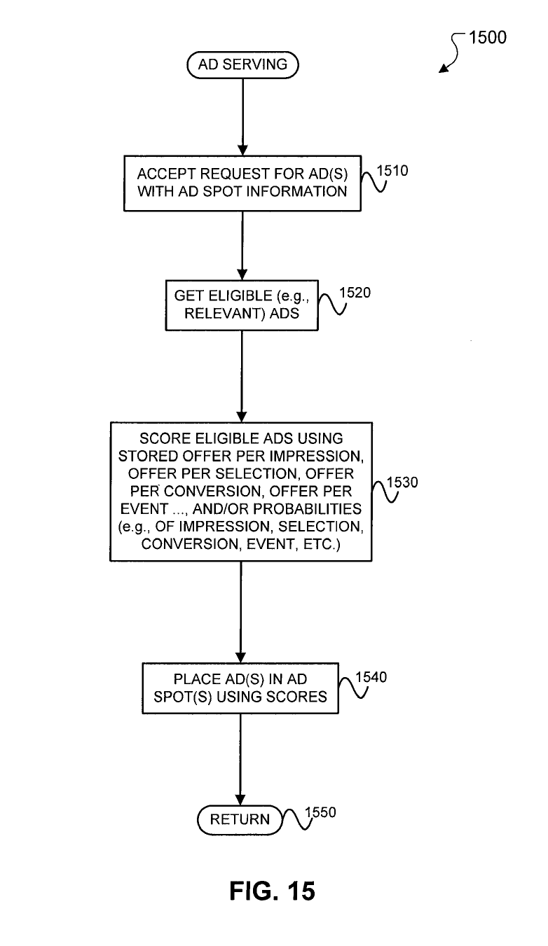

FIG. 15 is a flow diagram of an example process 1500 for serving ads. A request for ads (which may include ad spot information) is accepted (1510). Eligible ads (e.g., those relevant to the request) are obtained (1520). The obtained eligible ads are then scored using stored offer per impression, offer per selection, offer per conversion, offer per some other event, and/or probabilities (of impression being perceived, of selection, of conversion, of event, etc.) (1530). The ads are then placed in ad spots using the scores (1540) before the process 1500 is left (1550).

Referring back to block 1510, the ad spot information may include search query terms that generated a search page with ad spots, information about content of a document with ad spots, information about an offline property or publication with ad spots, etc.

Referring back to block 1520 eligible ads may be determined by comparing serving constraints used to target the serving of the ads with ad spot information. For example, targeting keywords may be compared with search query terms. As another example, targeting keywords may be compared with document information. As yet another example, geotargeting information may be compared with a location of a client device on which a Webpage with ad spots will be served. There are many different ways of determining whether or not an ad is eligible (e.g., relevant).

Referring back to block 1530, the score (or a component thereof) may be an estimated cost per 1000 impressions (“CPM”). In some implementations, an advertising network uses the following formula for each candidate ad:

eCPM=CPC*CTR*1000 [1]

The product of the CPC and the CTR is multiplied by 1000 to normalize the product of the CPC and the CTR (cost/impression) to a cost value per 1000 impressions.

This can be generalized by considering that a click is just an immediate event that has a value V_{click} (i.e., the CPC) and a probability P_{click} given the ad being served (i.e., the CTR). Thus, the eCPM can be expressed as:

eCPM=V_{c}*P_{c} [2]

In some implementations, various offers (e.g., per impression offers, per selection offers, per conversion offers, and per event offers) (recall, e.g., potential offers of template 1400 of FIG. 14.) are summed to compute the eCPM. At least one of the offers needs to be non-zero.

Since whether or not some events will occur is not known with certainty prior to serving the ads, estimated probabilities that the events will occur (e.g., CTRs) may be used. Thus, in the general case:

eCPM=Σ_{∀E}(V_{E}*P_{E}) [3]

where E is the set of all events (which may include impressions, selections, conversions) the advertiser values.

Regarding impressions, in some implementations, Pᵢ may be set to be Pᵢ=1.0. In some other implementations, this probability may be adjusted in view of the fact that certain ad spots are less likely to be perceived (e.g., seen) than others. (See, e.g., U.S. Patent Application Publication No. 2006/0224445 (and incorporated herein by reference), filed on Mar. 30, 2005, titled “ADJUSTING AN ADVERTISING COST, SUCH AS A PER-AD IMPRESSION COST, USING A LIKELIHOOD THAT THE AD WILL BE SENSED OR PERCEIVED BY USERS”.) This may be reflected in a modified notion of an impression, or by a separate “perception” or “sensing” event.

In some implementations in which advertisers can express their value in impressions, selections (clicks), and/or other events, the score may be expressed as:

eCPM=Vᵢ*Pᵢ+V_{c}*P_{c}+Σ_{∀e}(Vₑ*Pₑ) [4]

where e is the set of advertiser-defined events that they value.

The scoring techniques using equations [3] and [4] above work well when the advertiser is using conversion tracking to report all events that provide value to them. Unfortunately, however, many advertisers do not (and will not) use conversion tracking. Further, even advertisers that do use conversion tracking might not be able to report all events. For example, NIKE might report much of its value non-specifically because its value stems from offline merchandise sales that rarely, if ever, can be tied to specific ad impressions or selections. In this example, suppose that NIKE estimates that there is a 0.001 probability that a user who received a NIKE ad impression will purchase their shoes offline, and that the purchase gives them a $15.00 value on average. Thus, NIKE might assign an offer for an impression corresponding to be the product of the probability of a valued event given an impression and the value of the event to NIKE; namely=0.001*$15.00=$0.015. This corresponds to a $15.00 CPM offer (because CPM=offer per 1000 impressions). NIKE may additionally estimate that the probability of a similar offline purchase after the selection of an ad is 0.03. That means that NIKE's offer per selection would be the probability of a valued event given a selection and the value of the event to NIKE; namely=0.03*$15=$0.45. In this example, NIKE should offer $0.015 for each impression and $0.45 for each selection.

On the other hand, WINZIP may derive some value from view-through conversions (e.g., users that learn about the product's existence and later do a search and download or buy the software), some value from advertiser visiting the landing page, some value from the trial of the software, and further value from the final conversion in purchasing the software.

Referring back to block 1540, ads may be placed in ad spots (e.g., vertically arranged ads in a side margin of a webpage) using the scores. In some implementations, a minimum eCPM (and/or some minimum performance) may be enforced for the ad to be allowed to be placed in any ad spot, or in a particular ad spot. Alternatively, or in addition, ads may be provided with enhanced treatments (e.g., better fonts, better color styles, designs, images, animation, audio, video, etc.) depending on their score.

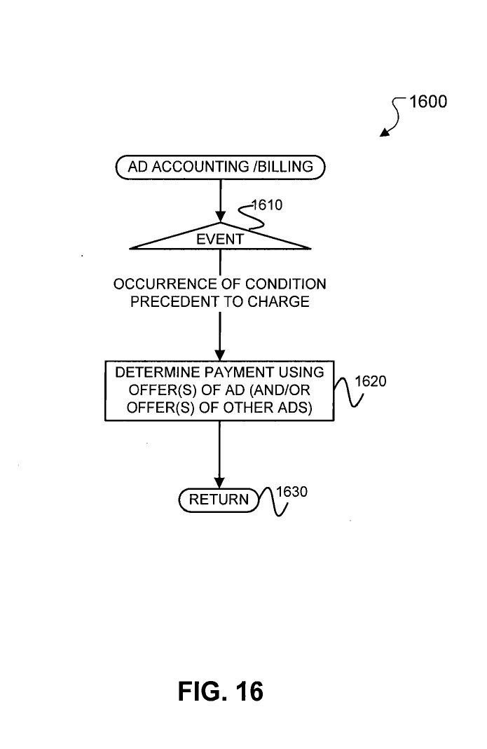

FIG. 16 is a flow diagram of an example process 1600 for billing advertisers. As shown, upon the occurrence of a condition precedent to charging the advertiser (1610), a payment is determined using the offer(s) associated with the advertiser's ad (and/or offers of other competing ads) (1620), before the process 1600 is left (1630).

Referring back to event 1610, there may be various conditions precedent to charging an advertiser. For example, in some implementations (option 1), the advertiser is charged only at the time of user ad selection (click) for the whole eCPM computed for the score. For example, the charge may be set to the ratio eCPM/CTR for each click. Under this first option, the payment might be determined as follows:

$${V}_{impression} \cdot the estimated number of impressions given selection + {V}_{selection} \cdot 1 + {\sum }_{∀ other events E} {V}_{E} \cdot P ( E \vert selection )$$

In some other implementations, (option 2), the advertiser is charged only at impression time for the eCPM computed for the score. This means advertisers may be charged a prorated, predicted-click fee, rather than paying only for actual clicks. Under this second option, the payment might be determined as follows:

$${V}_{impression} \cdot 1 + {V}_{selection} \cdot P ( selection \vert impression ) + {\sum }_{∀ other events E} {V}_{E} \cdot P ( E \vert impression )$$

In some further implementations (option 3), the advertiser is charged for impressions at the time of impression, and selections (and perhaps other events with offers) at the time of selection (if any). Under this third option, the payment might be determined as follows:

at time of impression: Vᵢₘₚᵣₑₛₛᵢₒₙ·1; and
at time of selection (if any)

$${V}_{selection} \cdot 1 + {\sum }_{∀ other events E} {V}_{E} \cdot P ( E \vert selection )$$

In some further implementations (option 4), the advertiser is charged for impressions at the time of impression time, selections at the time of selection (if any), and other events at the time of the occurrence of those other events. Under this fourth option, the payment might be determined as follows:

at time of impression: Vᵢₘₚᵣₑₛₛᵢₒₙ·1;
at time of selection (if any): V_{selection}·1; and
at time of each other event (if any): Vₑᵥₑₙₜ·1

In each case, the charge may reflect the advertiser's various offers for various events. In some implementations, the amount charged may depend on offers associated with other competing ads

The second option has some attractive characteristics. Unfortunately, however, the second option may be disadvantageous for advertisers that want to be assured of actual selections before payment. Advertisers, to maximize their value, need to trust the predictive ability of the system in estimating the frequency of clicks. Much of the marketing surrounding CPC-based advertising stresses “pay only for real clicks” and that attractive feature is not available under the second option.

Implementations using the third option could batch impressions into thousands (or some other predetermined number) before recognizing the billable event.

As mentioned above, in some implementations, if an ad is served, the probability of impression may be set to one. In some other implementations, the probability of impression may be the probability that the ad will be perceived or sensed by a user.

Referring back to FIG. 14, in implementations in which an advertiser specifies an incremental cost for a more specifically defined ad spot, the applicable baseline and specific offers should be combined. On the other hand, in implementations in which an advertiser specifies an absolute cost for a more specifically defined ad spot, only the most specific (or expensive) applicable offer should be considered. In either case, offers used (or not used) in scoring ads should be used (or not be used) in determining a charge for the advertiser.

In some of the implementations described above, the score was determined as eCPM. The score may be determined using additional factors. For example, a corrective factor to model the end user's value proposition could be added. More specifically, such a corrective factor may be used to prevent advertisers that value impressions (without some level of user interest expressed via clicks or deeper conversions) from overly dominating the arbitration for ad spots.

In some implementations, incentives could be provided to advertisers to increase offers for certain types of ad spots and/or certain types of events (e.g., impression offers for a “travel” vertical). For example, one incentive might be to decorating any ad that has at least a $5.00 CPM offer with the miniature icon of that advertiser's brand. Other incentives are possible.

In some implementations, a publisher (or a property owner), a network of publishers (or property owners), and/or an advertising network might offer an advertiser one or more incentives to make a larger spending commitment, or to commit to advertise across a wider range of properties (e.g., Web pages, Websites, publications, billboards, buses, etc.). One example of such an incentive would be to increase the score of an advertiser's ad(s). Such an increase could be applied to the scores of the advertiser's ad(s) in multiple ad spots. For example, the ad network might agree to increase the scores (used in arbitrations) of the ad(s) of the advertiser over a certain time period (e.g., a month) if the advertiser commits to spend at least a certain amount of money (e.g., $5000.00) over the time period. In this way, the ad network can consider a factor, in addition to eCPM, in ad scoring. Another example of such an incentive would be to discount (more than normal) the advertiser's payment(s).

### EXAMPLE COMPETITION FOR AD PLACEMENT

In the following simple examples, assume that the following two ads are competing for an ad spot. Similar scoring may occur when certain ads are keyword directed and other ads are keyword-less:

### AD 1: Nike

### Search:

keywords: sneaker, nike, footwear, sports, . . .

impression offer for any keyword match: $20.00/1000 impressions

impression offer for keyword “sneaker”: +$2.00/1000 impressions

impression offer for keyword “footwear”: +2.00/1000 impressions

### Content:

any publication or property: $20.00/1000 impressions

“sports illustrated” publication: +$30.00/1000 impressions

sports vertical: +$10.00/1000 impressions

### AD 2: Striderite

### CTR=0.08

### Search:

keywords: footwear, shoes, striderite, strideright, toddler,

impression offer for any keyword match: $2.00/1000 impressions

click offer for any keyword match: $1.00/click

click offer for keyword “striderite”: +$0.75/click

click offer for keyword “strideright”: +0.75/click

### Content:

any publication or property: $0.20/click

any publication or property: $1.00/1000 impressions

“parenting” publication: +$5.00/click

“parenting” publication: +$5.00/1000 impressions

Suppose that a search results page with an ad spot was generated in response to the query “footwear”. The ads would score as follows:

scoreₙᵢₖₑ=$20.00/1000+$2.00/1000=$22.00/1000=$0.022

score_{striderite}=$2.00/1000+$1.00*0.08=$0.002+$0.080=$0.082.

Thus, in this first scenario, the AD2 for Striderite scored higher than AD1 for Nike.

Now suppose that a webpage (from neither “Sports Illustrated”, nor “Parenting”) relevant to footwear has an ad spot. The ads would score as follows:

scoreₙᵢₖₑ=$20.00/1000=$0.020

score_{striderite}=$1.00/1000+$0.20*0.08=0.001+0.016=0.017

Thus, in this second scenario, the AD1 for Nike narrowly beat the AD2 for Striderite.

Finally, suppose that a webpage from the “Parenting” Website, that is relevant to footwear, has an ad spot. The ads would score as follows:

scoreₙᵢₖₑ=$20.00/1000=$0.020

score_{striderite}=$1.00/1000+$5.00/1000+$0.20*0.08+$5.00*0.08=0.001+0.005+0.016+0.400=0.422

Thus, in this third scenario, the AD2 for Striderite would handily beat theAD1 for Nike.

As the foregoing examples illustrate, different advertisers are able to express their value propositions (e.g., in terms of different types of offers for different types of ad spots).

Various implementations can use different ways of determining ad score. For example, the score may be determined using additional factors such as degree of relevance, end user utility, etc.

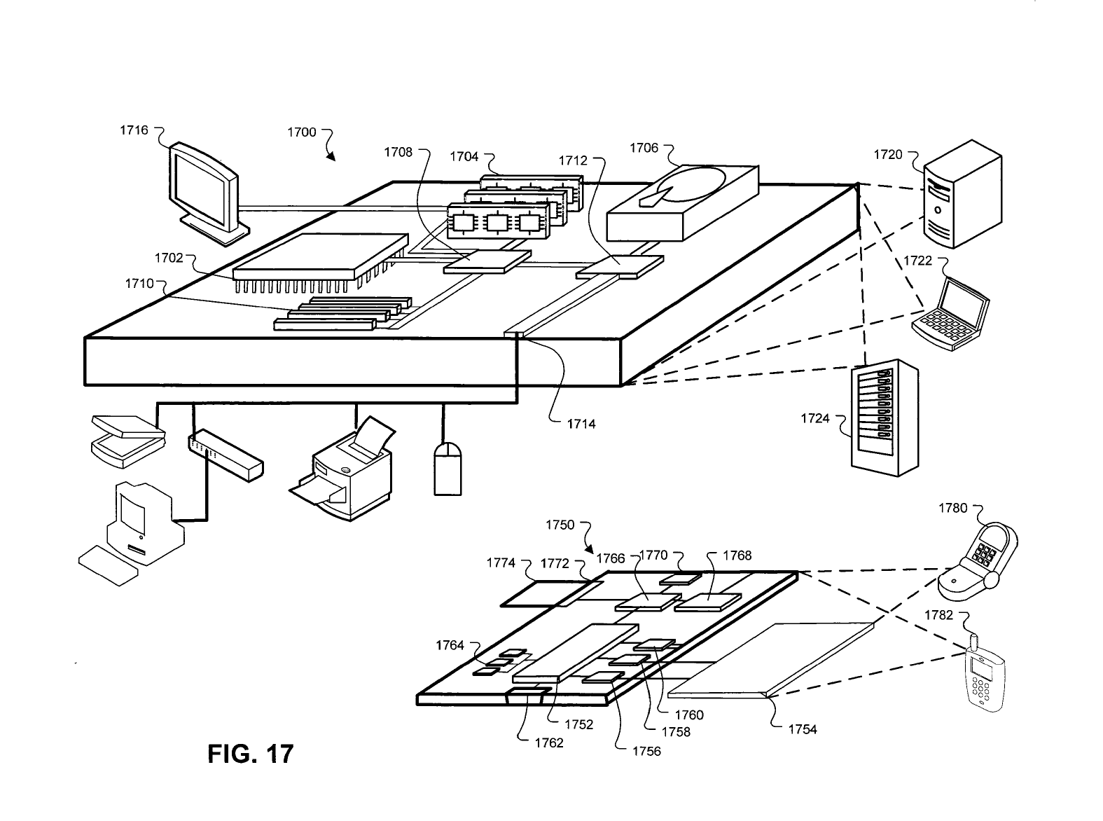

FIG. 17 shows an example of a generic computer device 1700 and a generic mobile computer device 1750, which may be used with the techniques described above. Computing device 1700 is intended to represent various forms of digital computers, such as laptops, desktops, workstations, personal digital assistants, servers, blade servers, mainframes, and other appropriate computers. Computing device 1750 is intended to represent various forms of mobile devices, such as personal digital assistants, cellular telephones, smartphones, and other similar computing devices. The components shown here, their connections and relationships, and their functions, are meant to be exemplary only, and are not meant to limit the implementations described and/or the claims.

Computing device 1700 includes a processor 1702, memory 1704, a storage device 1706, a high-speed interface 1708 connecting to memory 1704 and high-speed expansion ports 1710, and a low speed interface 1712 connecting to low speed bus 1714 and storage device 1706. Each of the components 1702, 1704, 1706, 1708, 1710, and 1712, are interconnected using various buses, and may be mounted on a common motherboard or in other manners as appropriate. The processor 1702 can process instructions for execution within the computing device 1700, including instructions stored in the memory 1704 or on the storage device 1706 to display graphical information for a GUI on an external input/output device, such as display 1716 coupled to high speed interface 1708. In other implementations, multiple processors and/or multiple buses may be used, as appropriate, along with multiple memories and types of memory. Also, multiple computing devices 1700 may be connected, with each device providing portions of the necessary operations (e.g., as a server bank, a group of blade servers, or a multi-processor system).

The memory 1704 stores information within the computing device 1700. In one implementation, the memory 1704 is a volatile memory unit or units. In another implementation, the memory 1704 is a non-volatile memory unit or units. The memory 1704 may also be another form of computer-readable medium, such as a magnetic or optical disk.

The storage device 1706 is capable of providing mass storage for the computing device 1700. In one implementation, the storage device 1706 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 1704, the storage device 1706, memory on processor 1702, or a propagated signal.

The high speed controller 1708 manages bandwidth-intensive operations for the computing device 1700, while the low speed controller 1712 manages lower bandwidth-intensive operations. Such allocation of functions is exemplary only. In one implementation, the high-speed controller 1708 is coupled to memory 1704, display 1716 (e.g., through a graphics processor or accelerator), and to high-speed expansion ports 1710, which may accept various expansion cards (not shown). In the implementation, low-speed controller 1712 is coupled to storage device 1706 and low-speed expansion port 1714. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 1700 may be implemented in a number of different forms, as shown in the figure. For example, it may be implemented as a standard server 1720, or multiple times in a group of such servers. It may also be implemented as part of a rack server system 1724. In addition, it may be implemented in a personal computer such as a laptop computer 1722. Alternatively, components from computing device 1700 may be combined with other components in a mobile device (not shown), such as device 1750. Each of such devices may contain one or more of computing device 1700, 1750, and an entire system may be made up of multiple computing devices 1700, 1750 communicating with each other.

Computing device 1750 includes a processor 1752, memory 1764, an input/output device such as a display 1754, a communication interface 1766, and a transceiver 1768, among other components. The device 1750 may also be provided with a storage device, such as a microdrive or other device, to provide additional storage. Each of the components 1750, 1752, 1764, 1754, 1766, and 1768, are interconnected using various buses, and several of the components may be mounted on a common motherboard or in other manners as appropriate.

The processor 1752 can execute instructions within the computing device 1750, including instructions stored in the memory 1764. The processor may be implemented as a chipset of chips that include separate and multiple analog and digital processors. The processor may provide, for example, for coordination of the other components of the device 1750, such as control of user interfaces, applications run by device 1750, and wireless communication by device 1750.

Processor 1752 may communicate with a user through control interface 1758 and display interface 1756 coupled to a display 1754. The display 1754 may be, for example, a TFT (Thin-Film-Transistor Liquid Crystal Display) display or an OLED (Organic Light Emitting Diode) display, or other appropriate display technology. The display interface 1756 may comprise appropriate circuitry for driving the display 1754 to present graphical and other information to a user. The control interface 1758 may receive commands from a user and convert them for submission to the processor 1752. In addition, an external interface 1762 may be provide in communication with processor 1752, so as to enable near area communication of device 1750 with other devices. External interface 1762 may provide, for example, for wired communication in some implementations, or for wireless communication in other implementations, and multiple interfaces may also be used.

The memory 1764 stores information within the computing device 1750. The memory 1764 can be implemented as one or more of a computer-readable medium or media, a volatile memory unit or units, or a non-volatile memory unit or units. Expansion memory 1774 may also be provided and connected to device 1750 through expansion interface 1772, which may include, for example, a SIMM (Single In Line Memory Module) card interface. Such expansion memory 1774 may provide extra storage space for device 1750, or may also store applications or other information for device 1750. Specifically, expansion memory 1774 may include instructions to carry out or supplement the processes described above, and may include secure information also. Thus, for example, expansion memory 1774 may be provide as a security module for device 1750, and may be programmed with instructions that permit secure use of device 1750. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 1764, expansion memory 1774, memory on processor 1752, or a propagated signal that may be received, for example, over transceiver 1768 or external interface 1762.

Device 1750 may communicate wirelessly through communication interface 1766, which may include digital signal processing circuitry where necessary. Communication interface 1766 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 1768. In addition, short-range communication may occur, such as using a Bluetooth, WiFi, or other such transceiver (not shown). In addition, GPS (Global Positioning System) receiver module 1770 may provide additional navigation- and location-related wireless data to device 1750, which may be used as appropriate by applications running on device 1750.

Device 1750 may also communicate audibly using audio codec 1760, which may receive spoken information from a user and convert it to usable digital information. Audio codec 1760 may likewise generate audible sound for a user, such as through a speaker, e.g., in a handset of device 1750. Such sound may include sound from voice telephone calls, may include recorded sound (e.g., voice messages, music files, etc.) and may also include sound generated by applications operating on device 1750.

The computing device 1750 may be implemented in a number of different forms, as shown in the figure. For example, it may be implemented as a cellular telephone 1780. It may also be implemented as part of a smartphone 1782, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

While the above-described implementations were described with reference to web-based advertising, the above-described implementations can be adapted for advertising in other media, such as radio, television, interactive games, and print media, for example.

A number of implementations have been described. Nevertheless, it will be understood that various modifications may be made. For example, various forms of the flows shown above may be used, with steps re-ordered, added, or removed. Other implementations are within the scope of the following claims.

What is claimed is:

1. A method, comprising:
receiving at a central system advertisement identifiers associated with one or more advertisements;
receiving one or more identifiers of web locations to be targeted by the advertisements;
receiving one or more non-keyword bids for a display of each of the advertisements; and
generating a score associated with each of the one or more advertisements using the non-keyword bid in an advertising auction.

2. The method of claim 1, further comprising selecting the one or more advertisements to display at the web locations if the generated score exceeds a predetermined level.

3. The method of claim 1, wherein generating the score associated with an advertisement comprises converting a keywordless score associated with the advertisement to a keyword-based score for comparison with keyword-based advertisements.

4. The method of claim 1, wherein a score for an advertisement associated with a non-keyword bid is generated for one or more displays of content associated with the web locations.

5. The method of claim 1, wherein the one or more identifiers of web locations comprise a web domain.

6. The method of claim 1, wherein the one or more identifiers of web locations comprise a URI.

7. The method of claim 1, wherein the one or more advertisement identifiers, the one or more identifiers of web locations, and the non-keyword bid are received from a single device remote from the central system.

8. The method of claim 1, further comprising comparing the generated score to one or more scores for keyword-based bids for other advertisements.

9. A system for delivering targeted advertisements, comprising:
computer storage storing a plurality of advertisements including keyword-based advertisements and keywordless advertisements;
an auction module to identify advertisements relevant to a view displayed to a user and to select candidate advertisements for display to the user; and
an advertisement positioner programmed to generate and compare scores for the keyword-based advertisements and the keywordless advertisements and to provide a set of ranked advertisements for display to the user.

10. The system of claim 9, wherein the advertisement positioner is programmed to convert scores for keyword-based advertisements into a format for keywordless advertisements before comparing the scores.

11. The system of claim 9, wherein the advertisement positioner is programmed to convert scores for keywordless advertisements into a format for keyword-based advertisements before comparing the scores.

12. The system of claim 9, wherein the advertisements are site-targeted advertisements.

13. The system of claim 9, wherein the ad positioner is part of the auction module.

14. A computer program product, encoded on a tangible program carrier, operable to cause a data processing apparatus to perform operations comprising:
receiving at a central system advertisement identifiers associated with one or more advertisements;
receiving one or more identifiers of web locations to be targeted by the advertisements;
receiving one or more non-keyword bids for the a display of each of the advertisements; and
generating a score associated with each of the one or more advertisements using the non-keyword bid in an advertising auction.

15. A system, comprising:
means for receiving at a central system advertisement identifiers associated with one or more advertisements;
means for receiving one or more identifiers of web locations to be targeted by the advertisements;
means for receiving one or more non-keyword bids for the a display of each of the advertisements; and
means for generating a score associated with each of the one or more advertisements using the non-keyword bid in an advertising auction.
